(19) United States
(12) Patent Application Publication
(10) Pub. No.: US 2017/0344308 A1
(43) Pub. Date: Nov. 30, 2017

(54) COMPUTER-READABLE RECORDING MEDIUM, DATA DELETION DETERMINATION METHOD, AND DATA DELETION DETERMINATION APPARATUS

(71) Applicant: FUJITSU LIMITED, Kawasaki-shi (JP)

(72) Inventors: Miho Murata, Kawasaki (JP); Nobutaka Imamura, Yokohama (JP); Hidekazu TAKAHASHI, Kawasaki (JP)

(73) Assignee: FUJITSU LIMITED, Kawasaki-shi (JP)

(21) Appl. No.: 15/599,904

(22) Filed: May 19, 2017

(30) Foreign Application Priority Data
May 24, 2016 (JP) 2016-103484

(51) Int. Cl. G06F 3/06; G06F 17/30

(52) U.S. Cl. CPC G06F 3/0652; G06F 17/3015; G06F 17/30117; G06F 17/3007; G06F 17/30489

(57) ABSTRACT

A computer-readable recording medium storing therein a data deletion determining program is disclosed. Deletion effect information indicating effect degrees due to deletions of a plurality of sets of output data is generated based on process contents, output data information, and an execution time. The plurality of sets of output data are generated over a course of a plurality of processes acquiring a final result acquired through a plurality of processes from subject data. The process contents are related to each of the plurality of processes. The output information is accumulated in a memory for the plurality of sets of the output data. The execution time is taken for one or more of the processes until generating the output data. The output data to be deleted from the memory is extracted based on respective sets of the deletion effect information for the plurality of the sets of the output data.

### CROSS-REFERENCE TO RELATED APPLICATIONS

This application is based upon and claims the benefit of priority of the prior Japanese Patent Application No. 2016-103484, filed on May 24, 2016, the entire contents of which are incorporated herein by reference.

### FIELD

The embodiments discussed herein are related to a computer-readable storage medium having stored therein a data deletion determination program, a data deletion determination method, and data deletion determination apparatus.

### BACKGROUND

In recent years, in order for a business to extract and use valuable information from a large amount of data (called “big data”) generated and accumulated in various situations, high level analysis technologies such as machine learning and the like have been frequently used. This machine learning uses a large capacity of storage area to repeat data processing.

It has been known to effectively use a storage area by technologies, in which the fewer the reference counts, or the older an estimated access time, data are deleted.

### PATENT DOCUMENTS

Japanese Laid-open Patent Publication No. 2003-022211

Japanese Laid-open Patent Publication No. 2013-174997

Japanese Laid-open Patent Publication No. H07-302224

Japanese Laid-open Patent Publication No. 2012-59204

### SUMMARY

According to one aspect of the embodiments, there is provision for a non-transitory computer-readable recording medium storing therein a data deletion determining program that causes a computer to execute a process including: generating deletion effect information indicating effect degrees due to deletions of a plurality of sets of output data based on process contents, output data information, and an execution time, the plurality of sets of output data being generated over a course of a plurality of processes acquiring a final result acquired through a plurality of processes from subject data, the process contents being related to each of the plurality of processes, the output information being accumulated in a memory for the plurality of sets of the output data, the execution time being taken for one or more of the processes until generating the output data; and extracting the output data to be deleted from the memory based on respective sets of the deletion effect information for the plurality of the sets of the output data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining a process for generating and evaluating one model;

FIG. 2 is a diagram for explaining an example of a successive feature extraction process using a genetic algorithm;

FIG. 3 is a diagram for explaining accumulation of output data for reuse;

FIG. 4 is a diagram illustrating an example, in which the feature extraction process is repeated when a high accuracy model is generated;

FIG. 5 is a diagram for explaining a first example of a deletion effect;

FIG. 6 is a diagram for explaining another example of the deletion effect;

FIG. 7 is a diagram illustrating an example of a functional configuration of an information processing apparatus;

FIG. 8 is a diagram illustrating a hardware configuration of the information processing apparatus;

FIG. 9 is a flowchart for explaining the first process example from receiving a process instruction to calculating a contribution degree;

FIG. 10A through FIG. 10C are diagrams for explaining a method for generating process content in step S702 in FIG. 9;

FIG. 11 is a flowchart for explaining a first example of a deletion order determination process;

FIG. 12 is a diagram for explaining a calculation method of the deletion effect information;

FIG. 13 is a diagram illustrating an example of the process contents;

FIG. 14 is a diagram illustrating a data example of a meta information table;

FIG. 15A, FIG. 15B, and FIG. 15C are flowcharts for explaining a second process example from receiving the process instruction until calculating the contribution degree;

FIG. 16 is a diagram illustrating a data example in the second process example in FIG. 15A through FIG. 15C;

FIG. 17 is a diagram illustrating data examples in the second process example in FIG. 15A through FIG. 15C;

FIG. 18 is a diagram for explaining a generation example of the process content; and

FIG. 19A through FIG. 19C are flowcharts for explaining the second example of the deletion order determination process.

### DESCRIPTION OF EMBODIMENTS

In machine learning, various feature extraction calculations are conducted to extract features of data. In the feature extraction calculations, there is a case in which output data of a certain process are accumulated as input data of another process. That is, the certain output data are related to another set of the output data, and a relationship strength varies depending on output data.

In the above described technology, the relationship strength of the output data is not considered. Hence, in the machine learning, if the output data having a strong relationship with another set of the output data are deleted, deletion of the output data may affect various feature extraction calculations. Such effects may potentially be imposed over a wide range.

Accordingly, an embodiment described below will present a computer-readable storage medium having stored therein a data deletion determination program, a data deletion determination method, and data deletion determination apparatus.

In the following, a preferred embodiment will be described with reference to the accompanying drawings. In an analysis by the machine learning, a model is generated for a prior prediction and a prior classification, and actual data are applied to the generated model. Then, an analysis result is acquired.

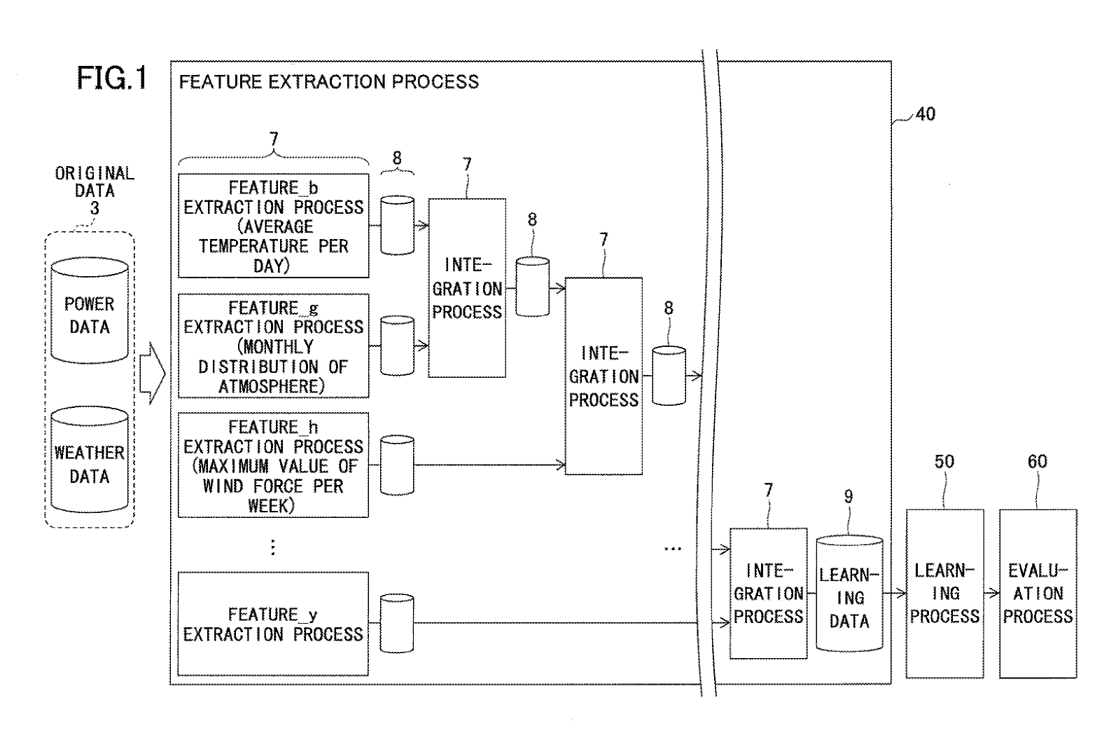

In order for an optimum model to be generated, a feature extraction process, a learning process, and an evaluation process are generally repeated until accuracy of the model becomes improved. The feature extraction process generates learning data by extracting feature data from original data. The learning process generates the model. The evaluation process evaluates the generated model. A process to be repeated will be described with reference to FIG. 1.

FIG. 1 is a diagram for explaining the process for generating and evaluating one model. In FIG. 1, the process to be repeated is conducted by a feature extraction process 40, a learning process 50, and an evaluation process 60, as described above.

The feature extraction process 40 creates learning data 9 by extracting data, which are effective to predict and classify, that is, which indicate feature information, from original data 3. The learning process 50 learns the model from the learning data 9 acquired by the feature extraction process 40. The evaluation process 60 applies evaluation data to the model generated by the learning process 50, and evaluates the accuracy of the model.

The feature extraction process 40 extracts feature information acquired by using various values of the original data 3. The feature information is effective to use for prediction and classification. The feature information corresponds to the learning data 9.

Generally, an analyst extracts feature data by using the various values of the original data 3 based on his/her experience. However, in recent years, here have been cases in which a number of features (a number of dimensions of target data) to be extracted from the original data 3 has vastly increased. Hence, it becomes difficult to extract useful features by manual operation.

Consequently, a feature extraction method may be considered in that various sets of the learning data 9 are generated by extracting various features, and useful features are finally specified by learning all sets of the various sets of the learning data 9. However, a longer time may be spent for the feature extraction process 40. In a case of a large amount of the features, it is difficult to extract all the features and learn and evaluate all the extracted features.

Hence, a successive feature extraction method has been presented. This method repeats to extract a small amount of features from all feature candidates, and to learn and evaluate the extracted features. As a method for determining which features are extracted for each trial (each of repetitions of the feature extraction process 40, the learning process 50, and the evaluation process 60), a genetic algorithm (GA) is known.

In the successive feature extraction method, features, which indicate a good evaluation result, tend to be retained. In the feature extraction by multiple trials, the same features are extracted multiple times. That is, a time-consuming process is performed multiple times.

However, the feature extraction process 40 is mostly formed by a plurality of processes 7 including a feature extraction process from the original data 3, an integration process, and the like. Thus, in general, output data 8 of a certain process 7 are temporarily stored, and are input to a next process 7.

For example, in a case of generating the learning data 9 from the original data 3 including power data, weather data, and the like, as the various processes 7, a feature_b extraction process, a feature_g extraction process, a feature_h extraction process, . . . , a feature_y extraction process, and one or more integration processes are performed.

In the feature_b extraction process, an average temperature per day is calculated. In the feature_g extraction process, a monthly distribution of a barometric pressure is calculated. In the feature_h extraction process, a maximum value of a wind speed per week is calculated. These processes are performed at an initial process stage using values (raw data) acquired from the original data 3. In the integration processes, two or more sets of the output data 8 acquired at the initial process stage are integrated, two or more sets of data including the output data 8 acquired at the initial process stage and the output data 8 acquired after one integration process are integrated, two or more sets of the output data 8 acquired after the integration processes are integrated, or the like.

A formation of the processes 7 in the feature extraction process 40 is changed, and the feature extraction process 40 is repeated multiple times. Also, the learning process 50 may be replaced with various different processes, and the feature extraction process 40 may be repeated.

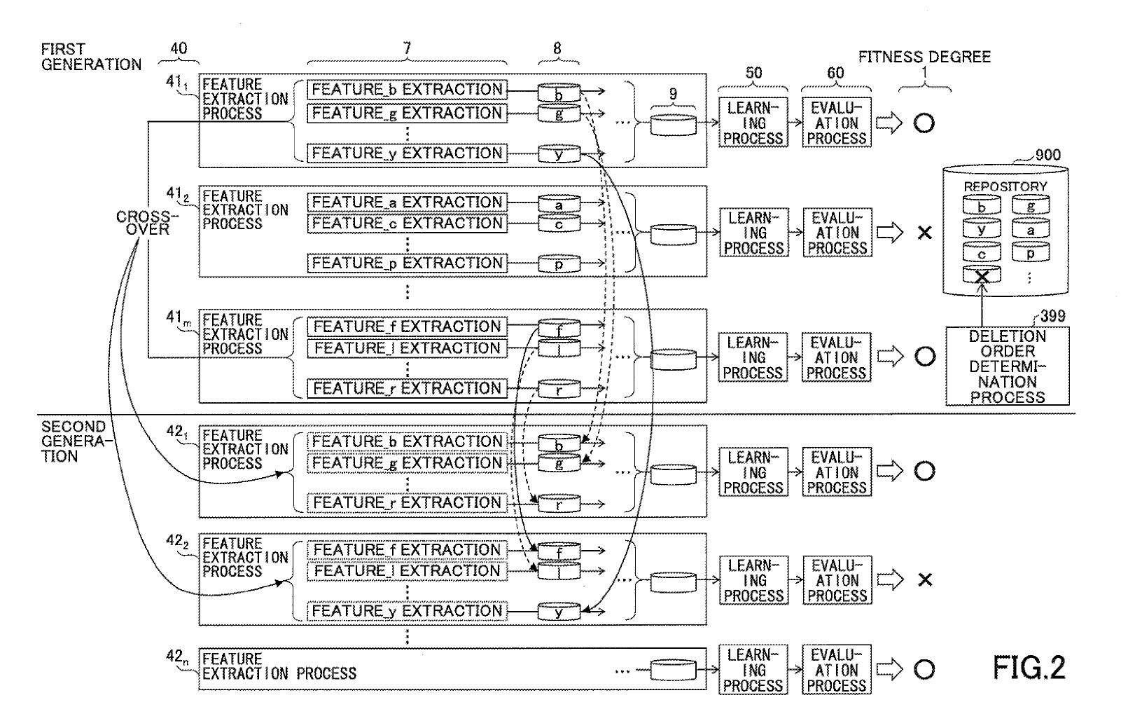

That is, if the output data 8 of a repetitive process are reused, the same time-consuming process does not need to be repeated. Thus, it is possible to greatly reduce an entire process time pertinent to the machine learning. The output data 8 corresponds to intermediate data in the feature extraction process 40. An example of the feature extraction process 40, which is successively conducted and uses the genetic algorithm, will be depicted in FIG. 2.

FIG. 2 is a diagram for explaining the example of the successive feature extraction process using the genetic algorithm. In FIG. 2, the example of the feature extraction process in a first generation and a second generation is illustrated.

In the first generation, the learning process 50 generates a model by using the learning data 9 acquired from each of feature extraction processes 41₁, 41₂, . . . , 41ₘ (collectively called “feature extraction processes 40”) for extracting combinations of different features, and the evaluation process 60 evaluates the model.

The evaluation process 60 evaluates how much the model generated by the learning process 50 predicts or classifies a certain item from new evaluation data. In the successive feature extraction process using the genetic algorithm, this evaluation result is applied with respect to a fitness degree in the genetic algorithm. For example, a mark “o” or a mark “x” indicates whether each of individuals (each of feature combinations) is suitable for a target prediction. The mark “o” indicates that prediction accuracy is greater than or equal to a threshold. The mark “x” indicates that the prediction accuracy is less than the threshold and that the learning data 9 suitable for the prediction is not acquired.

In the first generation, by a plurality of feature extraction processes 40, the features are randomly combined within a predetermined range of the combinations.

The features, which are extracted and combined for the learning data 9 and to which the fitness degree indicates “x”, are rarely applied for the following feature extraction process 40. In this example in the first generation, a combination of a feature_a, a feature_c, . . . , and a feature_p, which are extracted in the feature extraction process 41₂ having the fitness degree “x”, is rarely applied in the second and later generations.

In this example, a combination of a feature_b, a feature_g, . . . , and a feature_y in the feature extraction process 41₁, and a combination of a feature_f, a feature_l, . . . , and a feature_r in the feature extraction process 41ₘ in the first generation are applied in the second generation.

In the second generation, instead of combining the same features in the first generation, features are crossed over among the combinations in the first generation. That is, two combinations are selected among multiple combinations having the fitness degree “o” by a probability depending on the prediction accuracy, and there is substitution of features from among the two selected combinations.

In detail, the feature_y and the feature_r are replaced by each other from among the feature combination (b, g, . . . , y) of the feature extraction process 41₁ and the feature combination (f, l, . . . , r) of the feature extraction process 41ₘ. Accordingly, in the feature extraction process 41₁, data indicating the features acquired by the combination (b, g, . . . , r) and conducting the various processes are regarded as the learning data 9.

Also, in a feature extraction process 42₂, the features are extracted by the combination (f, l, . . . , y), the various processes 7 are conducted, and the learning data 9 are acquired. As described above, the features are crossed over among one or more combinations, and the feature extraction process 42₁ through 42₂.

Similar to the first generation, in the second generation, a combination of the features to which the fitness degree “x” is given, is rarely applied in a next three generations. However, after the second generation, features that have not been extracted from the original data 3 are extracted, and form a new combination to perform the machine learning.

Also, instead of changing a combination of the features, the learning process 50 may be replaced with another learning process.

As described above, the learning process 50 is conducted with the learning data 9, which are acquired by changing the combination of the features initially extracted from the original data 3, and the evaluation process 60 repetitively evaluates the learning data 9. Hence, it is possible to acquire optimal feature combinations to realize high prediction accuracy.

Additionally, in a case of generating the same output data 8 as that previously generated in a plurality of the feature extraction processes 40, the output data 8 previously generated are reused, and the output data 8 that were accumulated after being generated but have not been reused, are appropriately deleted. This operation is considered to realize suppressing of an increase of a data amount of the output data 8 to be accumulated. That is, it is possible to realize controlling against the increase of the data amount of the output data 8 to be accumulated.

In the embodiment, the greater effect on other processes due to deletion the output data 8 would have, the higher a priority is set to retain the output data 8. The output data 8 of a lower priority are deleted. Hence, it is possible to control against the effect of a deletion, and to delete the output data 8.

In the example depicted in FIG. 2, a deletion order is determined in consideration of a cost (a generation cost), a penalty, a contribution degree, and an effect degree by a deletion order determination process 399. The cost is one to generate the same output data 8. The penalty is applied to occupy a storage resource in a case of retaining the output data 8. The contribution degree indicates a degree how much a future process using the same output data 8 is affected. The effect degree indicates a degree how much another process is affected if the output data 8 are deleted. The output data 8, to which the priority is applied by the deletion order determination process 399, are deleted from a repository 900 in an ascending order of the priority until an available capacity of the storage resource exceeds a threshold.

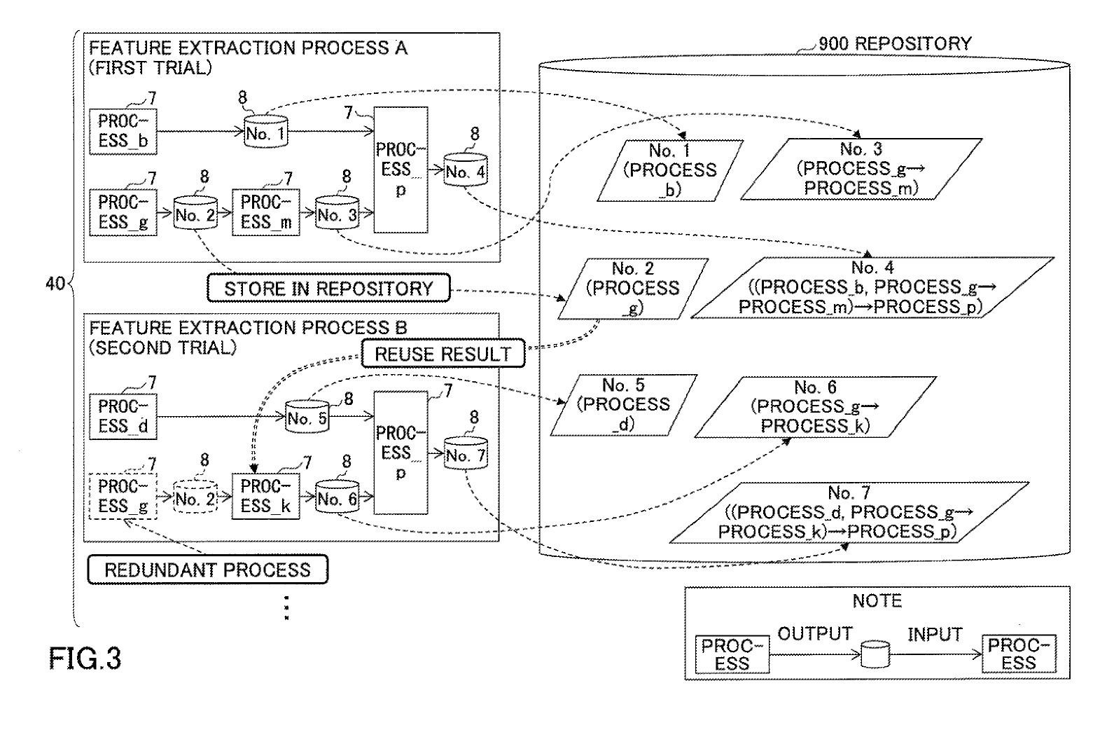

FIG. 3 is a diagram for explaining accumulation of the output data for reuse. In FIG. 3, the accumulation of the output data 8 to the repository 900 will be described in a case of performing the plurality of the feature extraction processes 40 including a feature extraction process A and a feature extraction process B.

The feature extraction process A corresponds to a first trial, and includes processes 7 of process names “process_b”, “process_g”, “process_m”, and “process_p”. The feature extraction process B corresponds to a second trial, and includes the process names “process_d”, “process_g”, “process_k”, and “process_p”. The same process name indicates that a same process program and a same argument are used. In a case in which input data are different even with the same process name, the output data 8 of these processes 7 are different. Here, it is assumed that the feature extraction process B is conducted after the feature extraction process A.

The accumulation of the output data 8 to the repository 900 by conducting the feature extraction process A will be described. In the feature extraction process A, the process_b inputs the original data 3 (FIG. 1), and generates the output data 8 of “No. 1”. The output data 8 of “No. 1” is stored with a process content “process_b” representing contents until the output data 8 are generated, in the repository 900.

Also, the process_g inputs the original data 3 (FIG. 2), and generates the output data 8 of “No. 2”. The output data 8 of “No. 2” is stored with a process content “process_g” representing contents until the output data 8 are generated, in the repository 900.

The process_m inputs the output data 8 of “No. 2”, and generates the output data 8 of “No. 3”. The output data 8 “No. 3” is stored with a process content “process_g->process_m” indicating contents until the output data 8 are generated, in the repository.

The process_p inputs sets of the output data 8 of “No. 1” and “No. 3”, and generates the output data 8 of “No. 4”. The output data 8 of “No. 4” are stored with a process content “(process_b, process_g->process_m)->process_p” in the repository 900.

That is, before the output data 8 of “No. 4” is generated, the process_b is conducted and the process_m is conducted after the process_g. Subsequently, the process_p is conducted. Hence, a process content “(process_b, process_g->process_m)->process_p” is stored.

As described above, the output data 8 are stored in the repository 900 with association of the process content indicating through which processes the output data 8 are generated.

Next, in the feature extraction process B, the process_d inputs the original data 3 (FIG. 1), and generates the output data 8 of “No. 5”. The output data 8 of “No. 5” is stored with a process content “process_d” in the repository 900.

In the process_g, the output data 8 of “No. 2”, for which the process_g alone is indicated as the process content, has been stored in the repository 900. In this case, instead of executing the process_g, the output data 8 of “No. 2”, which have been stored with the process content “process_g” in the repository, are reused as the input data to the process_k following the process_g. By the above described reuse, it is possible to control against an execution of redundant processes.

When the output data 8 of “No. 6” are generated by executing the process_k, the output data 8 of “No. 6” are stored with a process content “process_g->process_k” in the repository 900.

The process_p inputs two sets of the output data 8 of “No. 5” and “No. 6”, and generates the output data 8 “No. 7”. The output data 8 of “No. 7” are stored with the content process “(process_d, process_g->process_k)->process_p” in the repository 900.

That is, before the output data 8 of “No. 7” are generated, the process_d is conducted. Also, the process_k is conducted after the process_g. Subsequently, the process content “(process_d, process_g->process_k)->process_p” is stored to indicate that the process_p is conducted.

In machine learning, which conducts a successive feature extraction process, a feature extraction process, which contributes to generate a highly accurate model, tends to be repeated. Subsequently, the output data 8, which are used for the learning of the highly accurate model (for instance, the above described output data 8 of “No. 2” and the like), tend to be reused in following feature extraction processes. In the embodiment, a characteristic of the output data 8 in the above described feature extraction process is represented by the contribution degree.

In a case of deleting the output data 8, which tend to be reused, the process 7 is redundantly repeated, and the same output data 8 are repeatedly generated. In the embodiment, an order of deletion is determined in consideration of the cost (generation cost), the penalty, the contribution degree, and the effect degree. The cost is one to generate the same output data 8. The penalty refers to occupying the storage resource in a case of remaining the output data 8. The contribution degree indicates the degree to what extent a future process using the same output data 8 is affected. The effect degree indicates the degree to what extent another process is affected if the output data 8 are deleted. By deleting the output data 8 based on such as order, it is possible to realize the deletion of the output data 8 being accumulated in the repository 900 while controlling against effects due to the deletion.

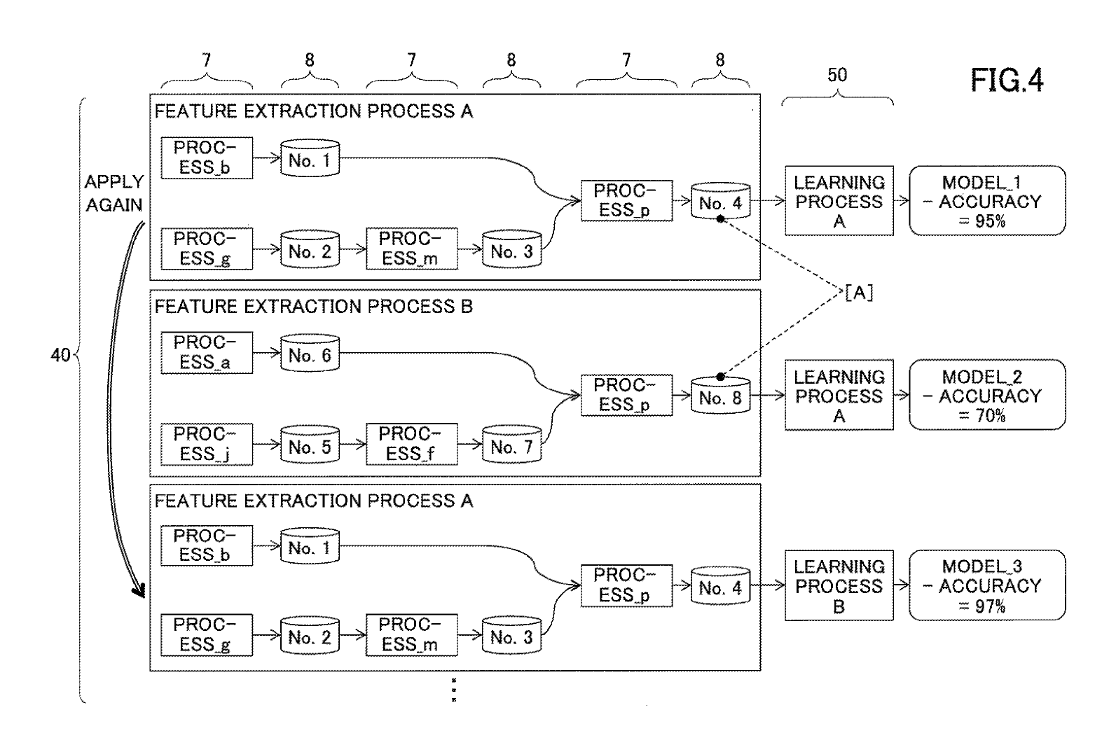

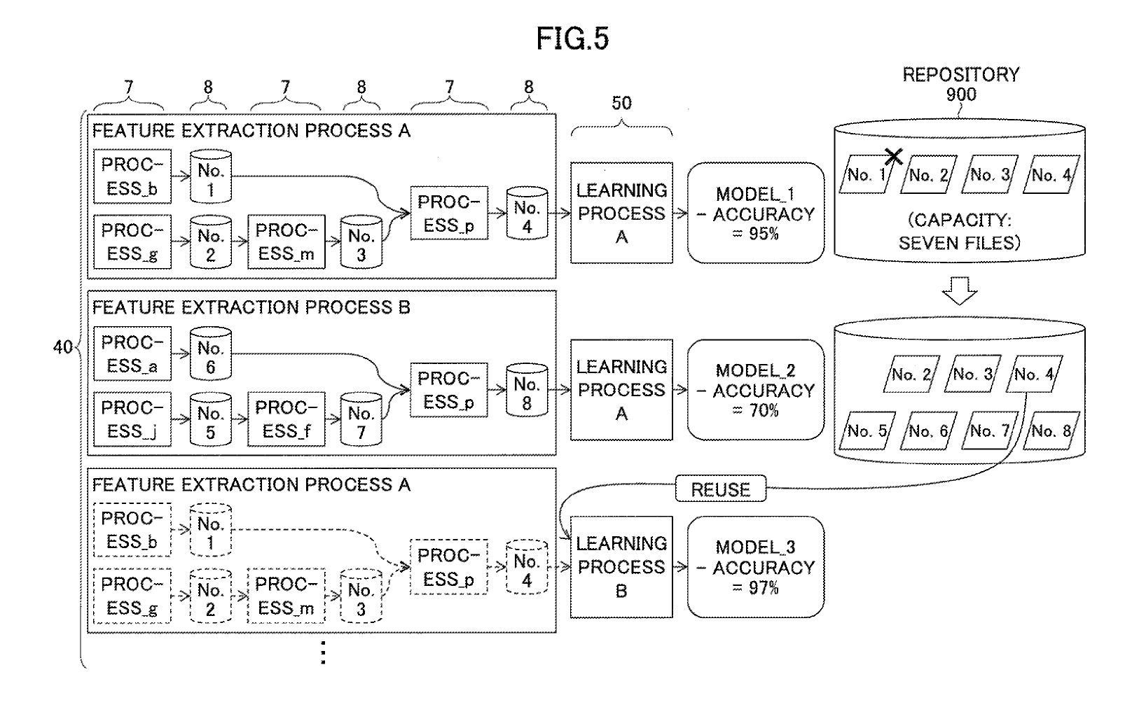

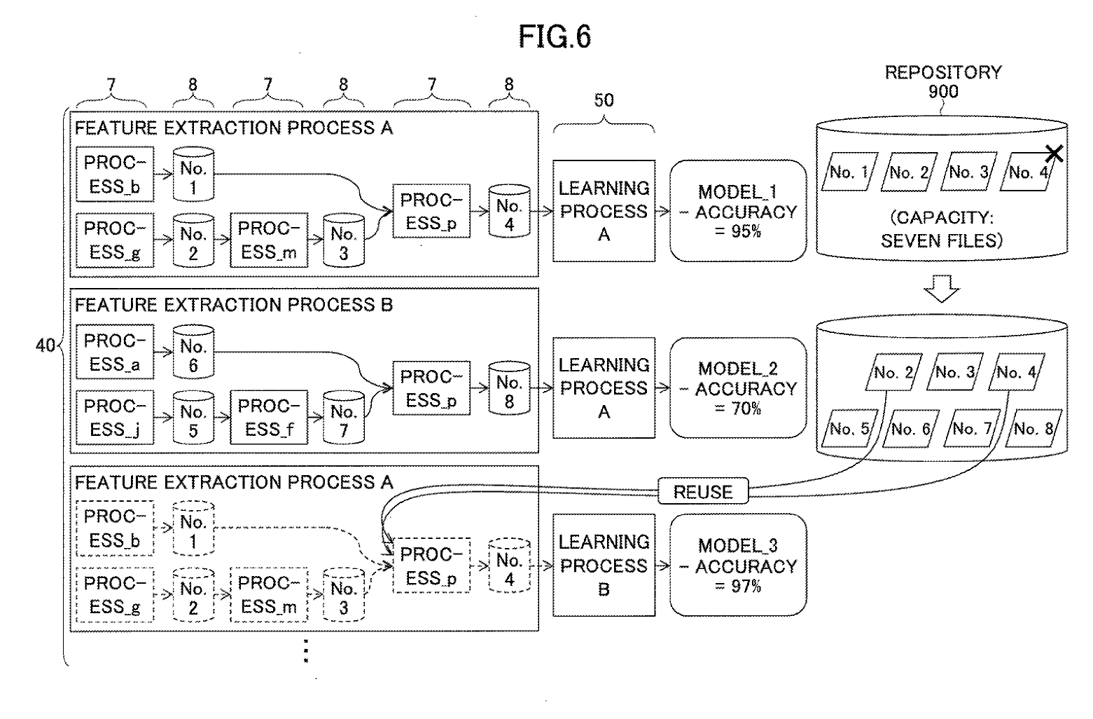

In a case in which the deletion of the output data 8 is not appropriate, the effect with respect to the machine learning will be described with reference to FIG. 4, FIG. 5, and FIG. 6. The deletion of the output data 8 may affect another process 7 in a case of using the following technologies:
a technology such as Web Caching or the like for calculating the priority based on an access frequency and a size of data, and deleting data from a lower priority,
a technology for deleting data from an oldest last access time (LRU: Least Recently Used),
a technology for deleting data from a lowest access frequency (LFU: Least Frequently Used), and the like.

In the successive feature extraction for the machine learning, if the accuracy of the model acquired by conducting one machine learning is high, the feature extraction process conducted for the machine learning tends to be tried again. Accordingly, even in a case of the same access frequency, the contribution degree to the future process may differ depending on the output data 8. That is, the contribution degree to the learning process 50 (an evaluation result) may differ.

In a technology for acquiring the priority of data based on information of respective actual access results and sizes of sets of data, a difference among the contribution degrees is not distinguished. For data targeted for cache use in Web caching, circumstances of the manner in which used and the effects at a later time depend on contents and the like of a Web service. Information (the access frequency, the access time, the size, and the like) of each set of data acquired by being cached does not necessarily correspond to the circumstances.

Also, in the successive feature extraction for the machine learning, since a plurality of processes are conducted in one machine learning, sets of the output data 8 are mutually related. That is, in a case of deleting one set of output data 8, this deletion may affect not only a process inputting the output data 8 but also several processes. Even for sets of the output data 8 having the same access frequency, the deletion may become different (FIG. 5 and FIG. 6).

In general, since a generation process of data to be a cache target is simple and has no relationship with other data, a dependency relationship among sets of the data may not be considered. In Web Caching, the generation process of an object to be the cache target is merely to retrieve data from a server. A circumstance, in which a target object is not acquired unless another object is acquired, does not usually occur. The deletion effect of the output data 8 in the machine learning will be described below.

FIG. 4 is a diagram illustrating an example, in which the feature extraction process is repeated when a high accuracy model is generated. In FIG. 4, as the feature extraction process 40, the feature extraction processes A, B, and the like are conducted. The accuracy of a model_1 acquired by the feature extraction process A and the learning process A is 95%, and the accuracy of a model_2 acquired by the feature extraction process B and the learning process A is 70%.

In the machine learning, the feature extraction process A used when the model_1 having the high accuracy is generated is applied again, and the feature extraction process A is combined with a learning process B different from the learning process A. The accuracy of this model_3 is 97%.

In a state [A] in which the model_1 and the model_2 are acquired, if the access result, the size, the last access time, and the like of each set of the output data 8 is used, the output data 8 to delete are not accurately determined. This example will be described with reference to FIG. 5 and FIG. 6. In FIG. 5 and FIG. 6, a capacity of the repository 900 is restricted to seven files.

FIG. 5 is a diagram for explaining a first example of the deletion effect. In FIG. 5, the effect on another process will be explained in an example case in which the output data 8 of “No. 1” generated at an initial stage in the feature extraction process 40 are deleted from the repository 900.

A case of using the above described existing LRU or the like will be described.
By performing the feature extraction process A, four sets of the output data 8: “No. 1”, “No. 2”, “No. 3”, and “No. 4” are accumulated in the repository 900.
The feature extraction process B is performed. When attempting to further accumulate four sets of the output data 8: “No. 5”, “No. 6”, “No. 7”, and “No. 8”, since the capacity of the repository 900 exceeds the seven files, the output data 8 of “No. 1” having the oldest last access time are deleted from the repository 900. Three sets of the output data 8 are retained in the repository 900.
Subsequently, four sets of the output data 8: “No. 5”, “No. 6”, “No. 7”, and “No. 8” are additionally stored in the repository 900.

Then, the feature extraction process A, which contributes to creating the model_1 having a 95% accuracy, is applied again, and creates the model_3 with the learning process B different from the learning process A of the model_1. In a case of creating the model_3, the output data 8 of “No. 1” do not exist in the repository. However, regardless of presence or absence of the output data 8 of “No. 1”, the output data 8 of “No. 4” retained in the repository 900 are reused, and the learning process B is carried out.

In the creation of the model_3, there is no output data 8 to newly accumulate in the repository 900. The deletion effect of the output data 8 of “No. 1” is less. In addition, by reusing the output data 8 of “No. 4”, it is possible to omit an execution of the entire processes 7 of the feature extraction process A.

FIG. 6 is a diagram for explaining another example of the deletion effect. In FIG. 6, the effect on another process will be described in a case of deleting the output data 8 of “No. 4” generated at a last stage of the feature extraction process 40.

In the creation of the model_1, by conducting the feature extraction process A, four sets of the output data 8 from “No. 1” to “No. 4” are stored in the repository 900.

A case of using the above described existing LFU or the like will be described.
By performing the feature extraction process A, four sets of the output data 8: “No. 1”, “No. 2”, “No. 3”, and “No. 4” are accumulated in the repository 900.
The feature extraction process B is performed. When attempting to further accumulate four sets of the output data 8: “No. 5”, “No. 6”, “No. 7”, and “No. 8”, since the capacity of the repository 900 exceeds the seven files, the output data 8 having the lowest access frequency are deleted from the repository 900. In this example, since respective access frequencies of all sets of the output data 8 are the same, the output data 8 of “No. 4” randomly selected from all sets of the output data 8 are deleted. Hence, three sets of the output data 8 are retained in the repository 900.
Subsequently, four sets of the output data 8: “No. 5”, “No. 6”, “No. 7”, and “No. 8” are additionally stored in the repository 900.

As a result, the feature extraction process A, which contributes to create the model_1 of the 95% accuracy, is applied, and creates the model_3 with the learning process B different from the learning process A of the model_1. In the creation of the model_3, the output data 8 of “No. 1”, “No. 2”, and “No. 3”, which are generated at earlier stages in the feature extraction process A, exist in the repository 900, and the output data 8 of “No. 4” of another process_p do not exist in the repository 900.

As a result, by tracing back to the earlier stages of the feature extraction process A, the process_p is conducted by reusing the output data 8 of “No. 1” and “No. 3”, and the output data 8 of “No. 4” are acquired. When generating again the output data 8 of “No. 4”, which had been deleted, the learning process B is conducted. As described above, in a case of deleting the output data 8 by a direct use prediction alone in the machine learning, a process for generating the output data 8 is again conducted. Hence, the above described method is not always appropriate.

As described above, in this example, the deletion effect of the output data 8, which are generated in a first process of each of the feature extraction processes A and B, is smaller. In contrast, the deletion effect of the output data 8, which are generated in a last process (immediately before the learning processes A or B) of each of the feature extraction processes A and B, is greater.

In the embodiment, by considering an effect degree on another process in a case of deleting the output data 8, and associating deletion effect information with each set of the output data 8, the priority is determined for each set of the output data 8. Accordingly, the output data 8 are deleted from the lower priority so that the greater the effect of a deletion, the lower the detection priority, and the lower the effect of a deletion, the higher the detection priority. Hence, it is possible to realize the deletion of the output data 8, to control against effects of deletion.

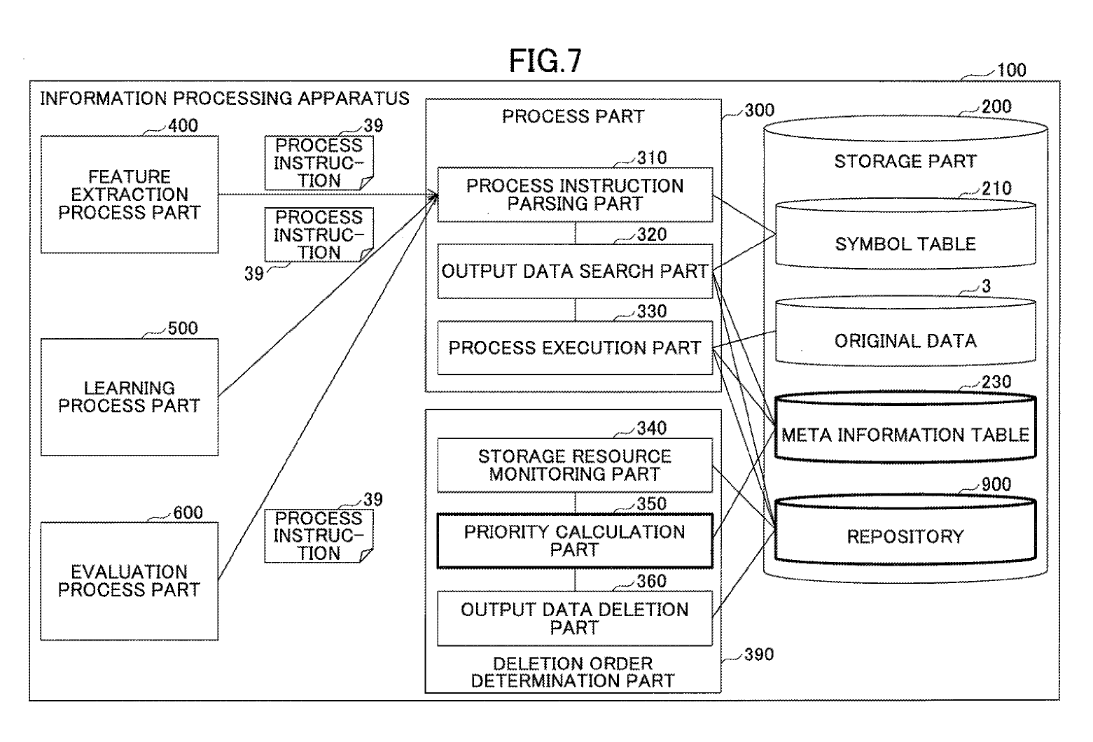

A functional configuration example in the embodiment of an information processing apparatus 100, which conduct the deletion order determination process 399 for deleting the output data 8 while controlling against the effect of the deletion, will be described. FIG. 7 is a diagram illustrating an example of a functional configuration of the information processing apparatus.

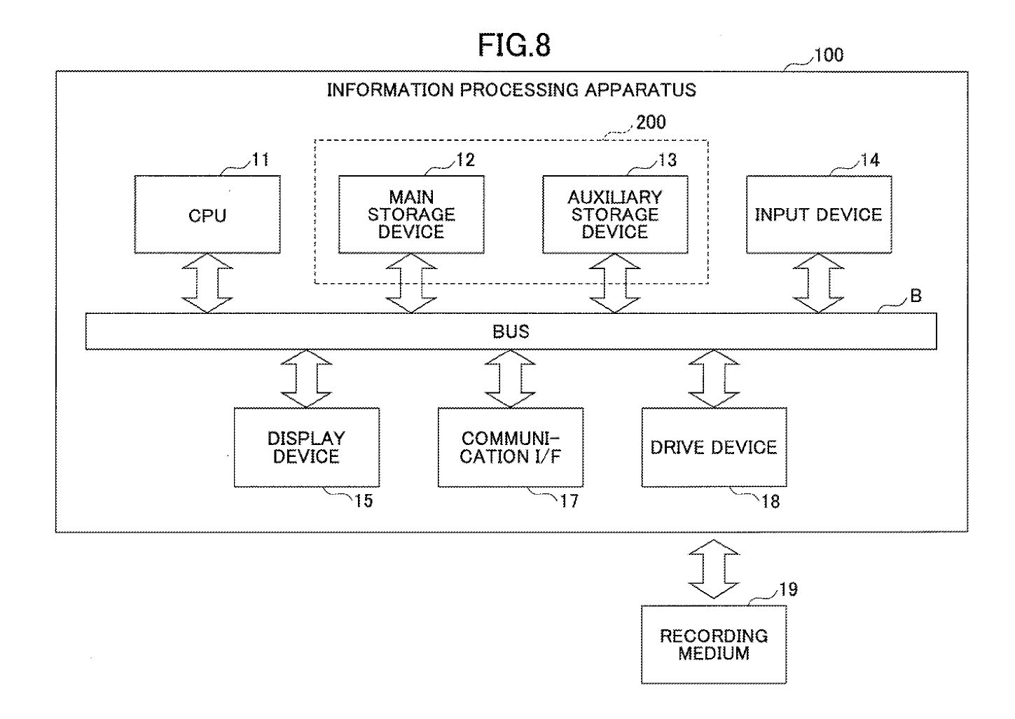

In FIG. 7, the information processing apparatus 100 corresponds to an apparatus that generates a model by the machine learning, and includes a feature extraction process part 400, a learning process part 500, an evaluation process part 600, a process part 300, and a deletion order determination part 390. Each of the feature extraction process part 400, the learning process part 500, the evaluation process part 600, the process part 300, and the deletion order determination part 390 is realized by a process, which a corresponding program installed into the information processing apparatus 100 causes a CPU 11 (FIG. 8) to execute.

Also, a storage part 200 of the information processing apparatus 100 stores a symbol table 210, the original data 3, a meta information table 230, the repository 900, and the like.

The feature extraction process part 400 conducts the feature extraction process 40. The learning process part 500 conducts the learning process 50. The evaluation process part 600 conducts the evaluation process 60.

The process part 300 receives a process instruction 39 from each of the feature extraction process part 400, the learning process part 500, and evaluation process part 600, conducts the process 7 in accordance with the process instruction 39, and generates the output data 8. The process part 300 accumulates, in the repository 900, the generated output data 8 with the process content until the output data 8 are generated. The process part 300 further includes a process instruction parsing part 310, an output data search part 320, and a process execution part 330.

The process instruction parsing part 310 creates the process content by referring to an analysis result of the process instruction 39, and stores an output name and the created process content in the symbol table 210. When the same output name exists in the symbol table 210, the output name and the created process content are not newly stored in the symbol table 210.

The output data search part 320 acquires the process content from the output name by referring to the symbol table 210, and searches the repository 900 by using an output ID associated with the process content from the meta information table 230.

When the output data 8 exist in the repository 900, the process 7 indicated by the process instruction 39 is determined as executed. That is, the execution of the process 7 by the process execution part 330 is not conducted. In contrast, when the output data 8 do not exist in the repository 900, the process 7 is executed by the process execution part 330.

When the output data 8 do not exist in the repository 900, the process execution part 330 executes the process 7 indicated by the process instruction 39. The process execution part 330 applies an output ID for uniquely specifying the output data 8 in the repository 900, with respect to the output data 8 generated by the execution of the process 7, and adds the output data 8 by associating with an execution time and the penalty acquired by executing the process 7 in the meta information table 230. The output data 8, to which the output ID is applied, are stored in the repository 900.

The execution time indicates time from a beginning to end of the process 7. The penalty represents the extent with respect to a consumed storage amount in the repository 900 the generated output data 8 occupy. The contribution degree is regarded as information indicating a degree of suitability when it is determined that a result of a process, which directly or indirectly uses the generated output data 8 as the input data, is appropriate.

The deletion order determination part 390 corresponds to a process part for conducting the deletion order determination process 399, and determines the deletion order in consideration with the cost (the generation cost) consumed to generate the output data 8, the penalty to an occupation of the storage resource in a case of retaining the output data 8, the contribution degree to the future process using the output data 8, and the effect degree on another process when the output data 8 are deleted. The output data 8 applied to the priority are deleted from the repository 900 in the ascending order of the priority until the available capacity of the storage resource exceeds the threshold. The deletion order determination part 390 further includes a storage resource monitoring part 340, a priority calculation part 350, and an output data deletion part 360.

The storage resource monitoring part 340 monitors the available capacity in the repository 900, and instructs the priority calculation part 350 to calculate the priority when detecting a state in which the available capacity is likely to become insufficient.

The priority calculation part 350 refers to the meta information table 230, and calculates the deletion effect information indicating the effect degree for a case of deleting the output data 8, based on the process content. Also, the priority calculation part 350 calculates the priority for each set of the output data 8 based on the execution time, the penalty, the contribution degree, and the calculated deletion effect information.

The output data deletion part 360 deletes the output data 8 from the lower priority calculated by the priority calculation part 350, from the repository 900.

The symbol table 210 is regarded as a table, which stores the process content by associating with the output name. The repository 900 is regarded as a storage area for accumulating the output data 8 with association of the output ID of the meta information table 230. The meta information table 230 is regarded as a table for storing the execution time, the penalty, the contribution degree, and the like.

In FIG. 7, the feature extraction process part 400, the learning process part 500, and the evaluation process part 600 may be implemented in a terminal connected to the information processing apparatus 100 through a network. Also, the original data 3 and the repository 900 may be retained and managed by separate servers or the like managing data. Also, the deletion order determination part 390 may be separately implemented in another apparatus.

The information processing apparatus 100 may include a hardware configuration in the embodiment as illustrated in FIG. 8. FIG. 8 is a diagram illustrating the hardware configuration of the information processing apparatus. In FIG. 8, the information processing apparatus 100 is controlled by a computer, and includes a Central Processing Unit (CPU) 11, a main storage device 12, an auxiliary storage device 13, an input device 14, a display device 15, a communication InterFace (I/F) 17, and a drive device 18, which are mutually connected via a bus B.

The CPU 11 corresponds to a processor that controls the information processing apparatus 100 in accordance with the program stored in the main storage device 12. The main storage device 12 includes a Random Access Memory (RAM), a Read Only Memory (ROM), and the like, and stores or temporarily stores the program executed by the CPU 11, data used in a process conducted by the CPU 11, data acquired in the process conducted by the CPU 11, and the like.

As the auxiliary storage device 13, a Hard Disk Drive or the like is used, to store data such as the programs to conduct various processes and the like. A part of the program stored in the auxiliary storage device 13 is loaded to the main storage device 12, and executed by the CPU 11, so as to realize the various processes. The main storage device 12 and the auxiliary storage device 13 correspond to the storage part 200.

The input device 14 includes a mouse, a keyboard, and the like, and is used by an analyzer such as a user to input various information items for the processes by the information processing apparatus 100. The display device 15 displays various information items for control of the CPU 11. The input device 14 and the display device 15 may be an integrated user interface such as a touch panel or the like. The communication I/F 17 conducts wired or wireless communications through a network. The communications by the communication I/F 17 are not limited as wireless or wired.

The program realizing the processes conducted by the information processing apparatus 100 may be provided to the information processing apparatus 100 by a recording medium 19 such as a Compact Disc Read-Only Memory (CD-ROM) or the like, for instance.

The drive device 18 interfaces between the recording medium 19 (the CD-ROM or the like) set into the drive device 18 and the information processing apparatus 100.

Also, the program, which realizes the various processes according to the embodiment, is stored in the recording medium 19. The program stored in the recording medium 19 is installed into the information processing apparatus 100 through the drive device 18, and becomes executable by the information processing apparatus 100.

The recording medium 19 storing the program is not limited to the CD-ROM. The recording medium 19 may be any type of a recording medium, which is a non-transitory tangible computer-readable medium including a data structure. The recording medium 19 may be a portable recording medium such as a Digital Versatile Disc (DVD), a Universal Serial Bus (USB) memory, or the like, or a semiconductor memory such as a flash memory.

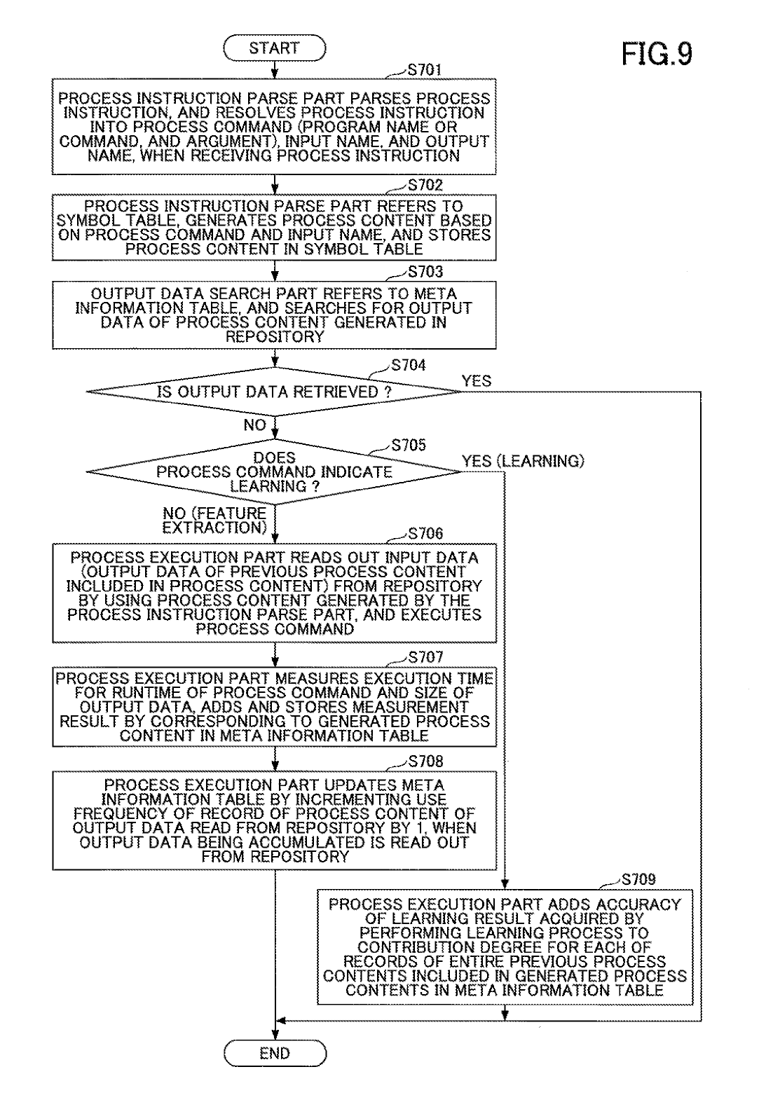

Next, a first process example of the process part 300 will be described. The first process example corresponds to a process until the contribution degree is calculated, from receiving the process instruction 39 to deleting the output data 8 in the information processing apparatus 100. FIG. 9 is a flowchart for explaining the first process example from receiving the process instruction to calculating the contribution degree. In FIG. 9, steps S701 through S709 are conducted by the CPU 11 every time the process instruction 39 is received.

When receiving the process instruction 39, the process instruction parsing part 310 parses the process instruction 39, and decomposes the process instruction 39 into a process command including a program name of the process or a command, and an argument, an input name, and the output name (step S701).

The process instruction parsing part 310 refers to the symbol table 210, which stores a previous process content for each of the process names, generates the process content of the received process instruction 39, and stores the generated current process content in the symbol table 210 (step S702). The process content is generated by tracing back the previous process contents so that the current process content may include one or more process contents previously conducted.

Next, the output data search part 320 refers to the meta information table 230, and searches for the output data 8 of the generated process content in the repository 900 (step S703). It is determined whether the generated process content exists in the meta information table 230. When the generated process content exists, it is determined that the output data 8 exist in the repository 900.

The output data search part 320 determines whether the output data 8 exist (step S704). When the output data 8 exist (YES of step S704), the deletion order determination process 399 is terminated without executing the process command.

In contrast, when the output data 8 do not exist (NO of step S704), the process execution part 330 checks whether the process command indicates the learning process 50 (step S705).

In order to distinguish a process type of the process command, a definition rule is defined to distinguish between the feature extraction process 40 and the learning process 50. As an example,

process type:

the “feature extraction process” and the “learning process” are distinguishable.

definition rule:

a prefix for the “feature extraction process”=“fs_”

a prefix for the “learning process”=“ml_”.

When the process command does not indicate the learning process 50 (NO of step S705), that is, any one of the processes 7 in the feature extraction process 40 is indicated, the process execution part 330 reads out the input data from the repository 900 by using the process content generated by the process instruction parsing part 310, and executes the process command (step S706). The output data 8 of the previous content included in the process content become the input data.

The process execution part 330 measures the execution time spent for the execution of the command and the size of the output data 8, and additionally records the execution time and the size in the symbol table 210 by associating with the generated process content (step S707).

When the process execution part 330 reads out the accumulated output data 8 as the input data from the repository 900, the process execution part 330 updates the meta information table 230 by incrementing the use frequency in a record of the process content of the read output data 8 by 1 (step S708). Next, the process conducted by the process part 300 is terminated.

In contrast, when the process command indicates learning (YES of step S705), the process execution part 330 adds, to the contribution degree in each of records of all the previous process contents included in the generated process content, a value representing a degree to which the output data 8 associated with the process content contributes to a learning result acquired by conducting the learning process. For instance, in a case of the machine learning accompanying with the successive feature extraction process using the genetic algorithm, the process execution part 330 adds the accuracy of a result (the model) of the learning using an individual (a combination of features) (step S709). Next, the process conducted by the process part 300 is terminated.

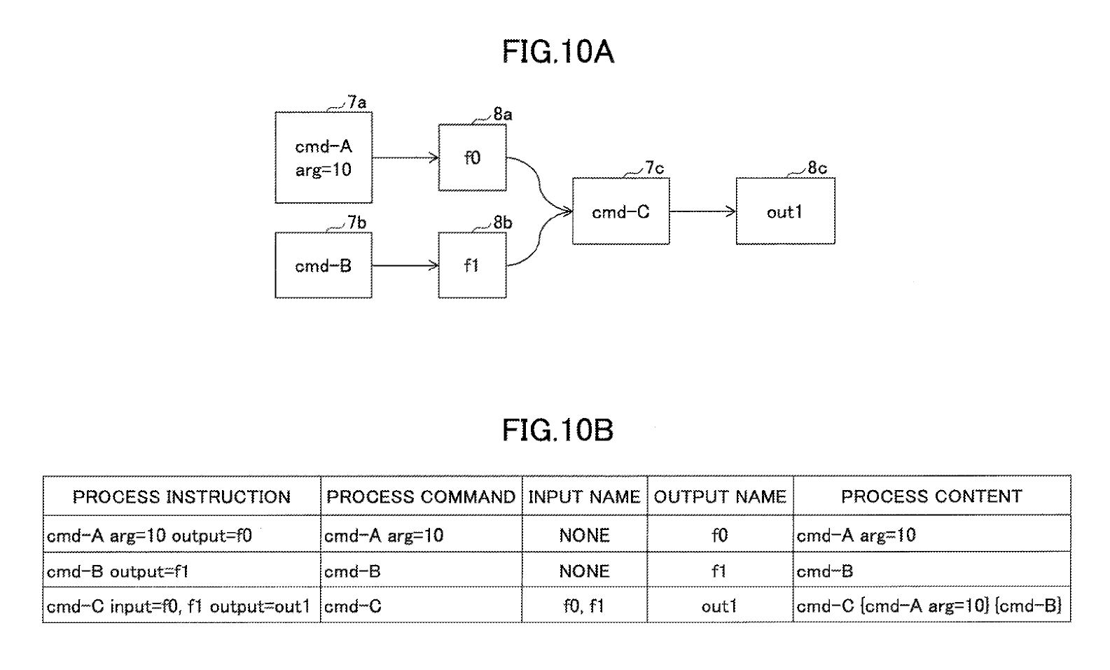

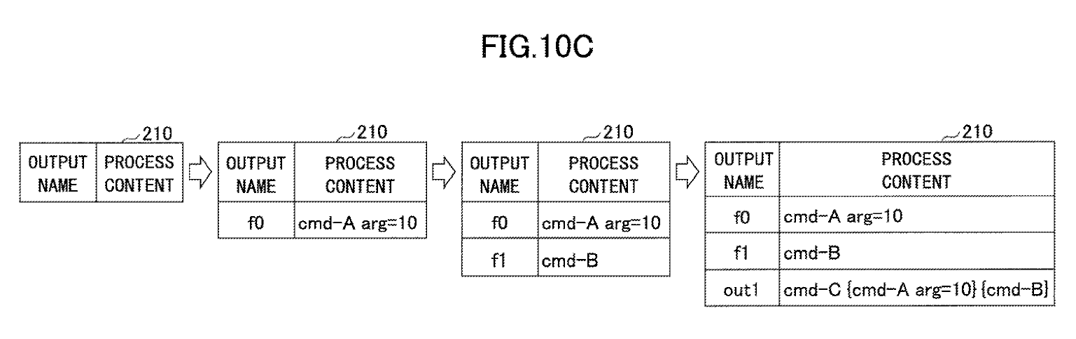

A method for generating the process content by the process instruction parsing part 310 in step S702 in FIG. 9 will be described. FIG. 10A through FIG. 10C are diagrams for explaining a method for generating the process content in step S702 in FIG. 9.

A method of generating the process contents will be described with the processing content in FIG. 10A as an example. Referring to FIG. 10A, a process 7a and a process 7b correspond to the initial process stage in which the features are extracted based on values of the original data 3. A process 7c corresponds to the last process stage in which output data 8c corresponding to the learning data 9 are generated. In a description example for the process 7a through the process 7c, “cmd” represents a command, and “arg” represents the argument. Accordingly, the process 7a is described as:
cmd-A
arg=10,
   where “cmd-A” specifies the command, “arg=10” indicates the argument “10”. The process 7b indicates “cmd-B”, and the process 7c indicates “cmd-C”. Also, output data 8a, 8b, and 8c are respectively specified by f0, f1, and out1.

Next, a generation example of the process contents will be described with reference to FIG. 10B and FIG. 10C. In FIG. 10B, in an order of receiving the process instructions 39, an analysis result of the process instruction parsing part 310 is exemplified. In FIG. 10C, a state transition of the symbol table 210 is illustrated.

First, when receiving the process instruction 39 of “cmd-A arg=10 output=f0”, the process instruction parsing part 310 resolves the process instruction 39 into a process command “cmd-A arg=10” and output name “f0”. In this example, since no input name is included, “none” is determined as the input name.

Since there is no input name in the process instruction 39, the process instruction parsing part 310 does not search for the symbol table 210. The process instruction parsing part 310 determines “cmd-A arg=10” as the process content, and adds a record, in which a content “cmd-A arg=10” is associated with the output name “f0” of the analysis result, to the symbol table 210.

One record, in which the content “cmd-A arg=10” is associated with the output name “f0”, is added to the symbol table 210, which is in an initial state, that is, in an empty state.

Next, when receiving the process instruction 39 of “cmd-B output=f1”, the process instruction parsing part 310 resolves the process instruction 39 into a process command “cmd-B” and an output name “f1”. In this case, since the input name is not included, the input name is determined as “none”.

Since no input name exists in the process instruction 39, the symbol table 210 is not searched. The process instruction parsing part 310 determines “cmd-B” as the process content, and adds a new record, in which the content “cmd-B” is associated with the output name “f1” of the analysis result, to the symbol table 210.

Moreover, when receiving the process instruction 39 of “cmd-C input=f0,f1 output=out1”, the process instruction parsing part 310 resolves the process instruction 39 into a process command “cmd-C”, the input names “f0, f1”, an output name “out1”, and a process content “cmd-C {cmd-A arg=10} {cmd-B}”.

The process instruction parsing part 310 searches for the output name of the symbol table 210 by using each of the input names “f0” and “f1” indicated by the process instruction 39. The process instruction parsing part 310 acquires the process content “cmd-A arg=10” from the record of the output name “f0”, which is searched for in the symbol table 210 by using the input name “f0”. Also, the process instruction parsing part 310 acquires the process content “cmd-B” from the record of the output name “f1”, which is retrieved from the symbol table 210 by using the input name “f1”.

Accordingly, the process instruction parsing part 310 generates the process content “cmd-C {cmd-A arg=10} {cmd-B}” representing the process contents including from the current process 7c until the previous processes 7a and 7b in accordance with the above described description format, and adds the record, in which the process content “cmd-C {cmd-A arg=10} {cmd-B}” is associated with the output name “out1” of the analysis result, to the symbol table 210.

Next, for every time receiving the process instruction 39, the process instruction parsing part 310 searches for the output name of the symbol name by the input name acquired by analyzing, and acquires the previous process contents. The process instruction parsing part 310 generates the process content of the received process instruction 39 in a predetermined description format. Also, the process instruction parsing part 310 adds the record, in which the generated process content is associated with the output name acquired by the analysis, to the symbol table 210.

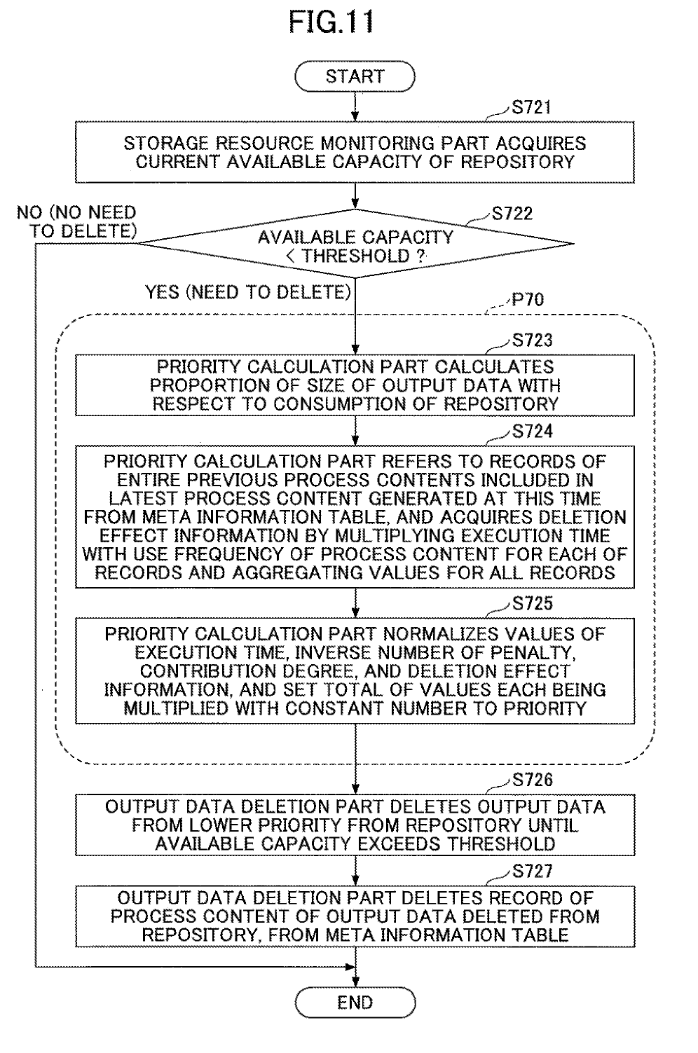

Next, the deletion order determination process 399 conducted by the deletion order determination part 390 will be described. FIG. 11 is a flowchart for explaining a first example of the deletion order determination process. The deletion order determination process 399 illustrated in FIG. 11 is periodically conducted.

In FIG. 11, the storage resource monitoring part 340 acquires a current available capacity of the repository 900 (step S721), and determines whether the available capacity is less than a threshold for a deletion order determination (step S722). When the available capacity is greater than or equal to the threshold (NO of step S722), the deletion order determination process 399 is terminated.

In contrast, when the available capacity is less than the threshold (YES of step S722), a process P70 is conducted with respect to all records of the meta information table 230 (that is, all the process contents). The process P70 includes steps S723 through S725 performed by the priority calculation part 350 and the output data deletion part 360.

The priority calculation part 350 reads out one record from the meta information table 230, refers to the read record, calculates a proportion of the size of the output data 8 to the consumed storage amount in the repository 900 at this point, and sets the calculated proportion as the penalty (step S723).

The priority calculation part 350 refers to records of all the previous process contents included in a latest process content generated by the process instruction parsing part 310 at this point from the meta information table 230, and acquires the deletion effect information by aggregating values acquired by multiplying the execution time with the use frequency of the generated process contents for each of the records (step S724).

Next, the priority calculation part 350 normalizes values of the execution time, an inverse number of the penalty, the contribution degree, and the deletion effect information, acquires a value by multiplying a constant value with each of normalized values, and sets a total of the acquired values as the priority (step S725).

After the process P70 is conducted for all records of the meta information table 230, the output data deletion part 360 deletes the output data 8 from the low priority from the repository 900 until the available capacity exceeds the threshold (step S726). Next, the output data deletion part 360 deletes the record of the process content of the output data 8, which are deleted from the repository 900, from the meta information table 230 (step S727). Next, the deletion order determination process is terminated.

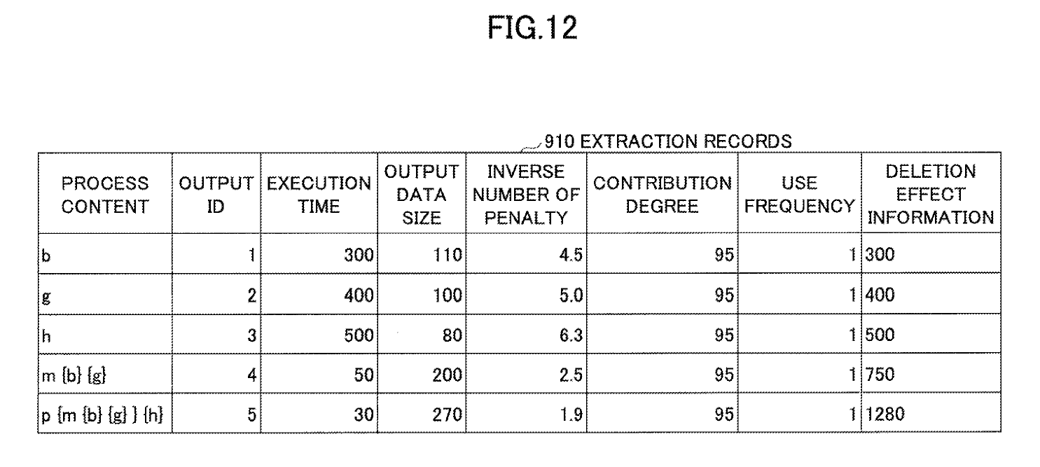

A calculation method of the deletion effect information in step S724 in FIG. 11 will be described. FIG. 12 is a diagram for explaining the calculation method of the deletion effect information. In FIG. 12, a data example of record of all the previous process contents included in the latest process content in the meta information table 230 is illustrated. In the following, this data example is referred to as extraction records 910.

In FIG. 12, the extraction records 910 include items of “PROCESS CONTENT”, “OUTPUT ID”, “EXECUTION TIME”, “OUTPUT DATA SIZE”, “INVERSE NUMBER OF PENALTY”, “CONTRIBUTION DEGREE”, “USE FREQUENCY”, “DELETION INFLUENCE INFORMATION”, and the like.

The item “PROCESS CONTENT” indicates the process content generated by the process instruction parsing part 310. The item “OUTPUT ID” indicates a number for specifying the output data 8, and is applied to the output data 8 when the output data 8 are generated. The output data 8 are retained in the storage part 200 as the output ID is set as a file name. It becomes easier to specify the output data 8 when the output data 8 are reused.

The item “EXECUTION TIME” indicates time from the beginning to the end of the process 7 executed by the process execution part 330. The item “OUTPUT DATA SIZE” indicates a data size of the output data 8. The item “INVERSE NUMBER OF PENALTY” records a value acquired by inversing a calculated penalty.

The item “CONTRIBUTION DEGREE” indicates a degree to what extent the process content contributes to the learning result of the output data 8. In the embodiment, the accuracy of the model is set. The item “USE FREQUENCY” indicates a count of how many times the output data 8 are used. The item “DELETION EFFECT INFORMATION” indicates the effect degree with respect to the process 7 inputting the output data 8 in a case of deleting the output data 8.

The penalty is calculated by the following expression:

size of output data 8/consumed storage amount.

The inverse number of the penalty is set to the extraction record 910.

The deletion effect information of a certain process content is acquired by calculating the following expression for each of the previous process contents related to the process:

execution time×use frequency,

and by aggregating calculated values for all the previous process contents related to the process.

The extraction records 910 illustrated in FIG. 12 correspond to multiple records extracted from the repository 900 in a case in which the latest process content is “p{m{b}{g}}{h}”. The extraction records 910 are formed by a record of the process content “p{m{b}{g}}{h}” and records of respective process contents included in the process content “p{m{b}{g}}{h}”, which are extracted from the repository 900.

In detail, two records of the process content “m{b}{g}” and the process content “h” are extracted based on the process content “p{m{b}{g}}{h}”. Furthermore, two records of the process content “m{b}{g}” and the process content “b” are extracted based on the process content “m{b}{g}”. Total five records are extracted.

In the extraction records 910, as described above, a depth of the process content is represented by using parentheses { }, and the process name being included is indicated in the parentheses { }. For instance, in the process content represented by

p{m{b}{g}}{h},

the process_p, which is positioned immediately before the output data 8 of “No. 5” is generated, is first defined in this format. Every process 7 traced back from the process_p is indicated by a process identification such as a process name or the like in { }. This process content indicates that immediately before the process_p, the process_m and the process_h are conducted. Moreover, this process content indicates that immediately before the process_m, the process_b and the process_g are conducted.

By representing all the process contents until the output data 8 are generated in the above described description format, five records are extracted based on the process content “p{m{b}{g}}{h}”.

In this data example, by referring to the record of the process content “b” generating the output data 8 of “No. 1”, the inverse number of the penalty is acquired based on the execution time “300” and the size “110” of the output data 8. Since the process content “b” does not include a further process content, a value acquired by multiplying the execution time “300” with the user frequency “1” for the process content “b” alone is set to the deletion effect information.

For the process content “g” and the process content “h” generating the output data 8 of “No. 2” and “No. 3”, respectively, the calculation is conducted in the same manner. The inverse number of the penalty “5.0” is acquired based on the execution time “400” and the size “100” of the output data 8 of the process content “g”. Since the process content “g” does not include a further process content, the execution “400” alone is set to the deletion effect information. The inverse number “6.3” of the penalty is acquired based on the execution “500” of the process content “h” and the size “80” of the output data 8. Since the process content “h” does not include a further process content, a value acquired by multiplying the execution time “500” with the user frequency “1” for the process content “h” alone is set to the deletion effect information.

Regarding the process content “m{b}{g}”, which generated the output data 8 of “No. 4”, the inverse number “2.5” of the penalty is acquired based on the execution time “50” and the output data size “200”. The process content “m{b}{g}” further includes the process content “b” and process content “g”. Accordingly, the execution time “300” of the process content “b”, the execution time “400” of the process content “g”, and the execution time “50” of the process content “m{b}{g}” itself are aggregated and a total value “750” (=300+400+50) is acquired. The total value “750” is multiplied with the use frequency “1” and is set to the deletion effect information.

Regarding the process content “p{m{b}{g}}{h}”, which generated the output data 8 of “No. 5”, the inverse number “1.9” of the penalty is acquired based on the execution “30” and the output data size “270”. The process content “p{m{b}{g}}{h}” includes the process content “b”, the process content “g”, the process content “m{b}{g}”, and the process content “h”. Accordingly, the execution time “300” of the process content “b”, the execution time “400” of the process content “g”, the execution time “50” of the process content “m{b}{g}”, the execution time “500” of the process content “h”, and the execution time “30” of the process content “p{m{b}{g}}{h}” itself are aggregated and a total value “1280” (=300+400+50+500+30) is acquired. The total value “1280” is multiplied with the use frequency “1” and is set to the deletion effect information.

In the embodiment, furthermore, an adjustment such as a normalization is conducted, and the priority is determined. Then, the output data 8 are deleted from the repository 900 in accordance with the determined priority.

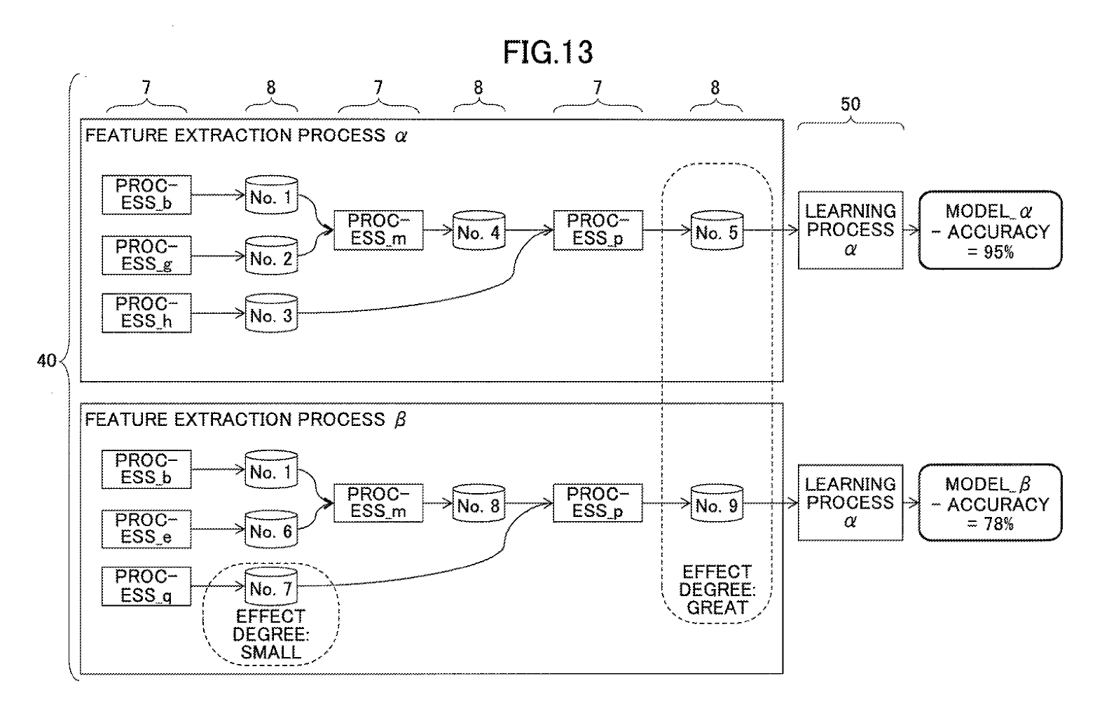

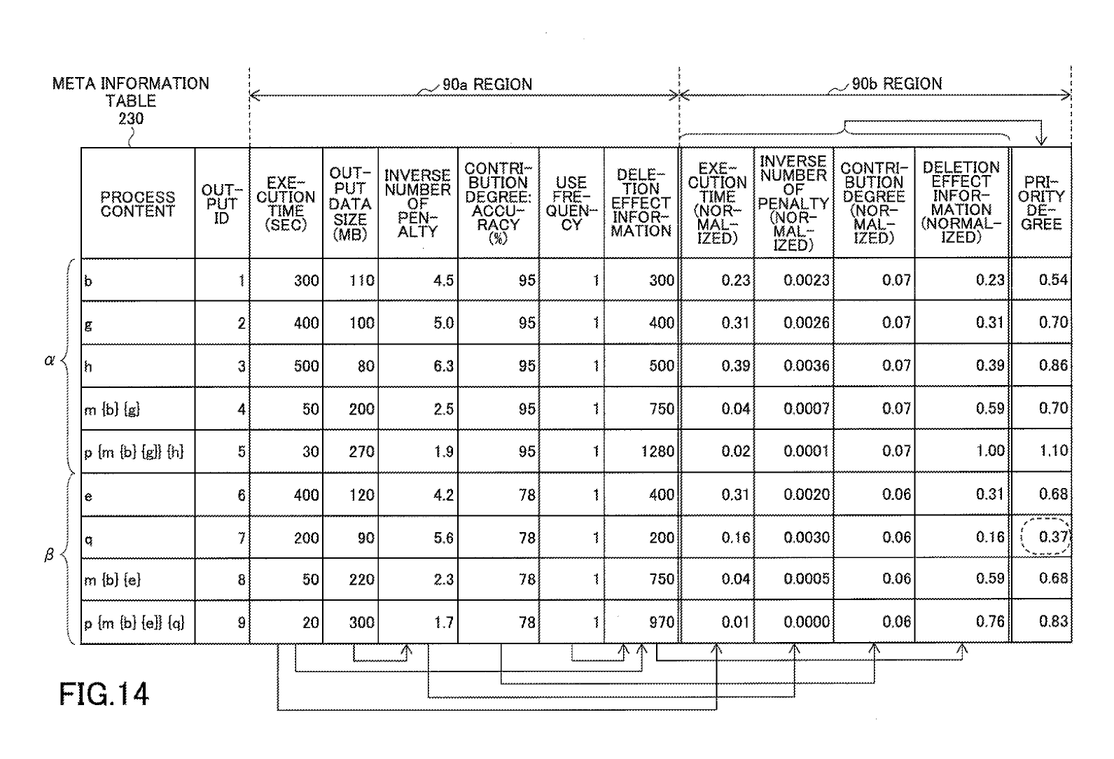

Next, referring to process contents in FIG. 13 as an example, a data example of the meta information table 230 will be illustrated in FIG. 14, and a deletion example of the output data 8 will be explained. In the embodiment, characteristics of the machine learning are considered.

FIG. 13 is a diagram illustrating an example of the process contents. In FIG. 13, a feature extraction process a and a feature extraction process β are conducted as the feature extraction processes 40. The feature extraction process β is conducted after the feature extraction process α is conducted.

In FIG. 13, the feature extraction process a includes five processes 7. The process_b, the process_g, and the process_h are conducted at the initial stage. The output data 8 of “No. 1” are generated by the process_b, the output data 8 of “No. 2” are generated by the process_g, and the output data 8 of “No. 3” are generated by the process_h.

At a middle stage, sets of the output data 8 of “No. 1” and “No. 2” are used as the input data to the process_m, and the output data 8 of “No. 4” are generated by the process_m. At a subsequent stage, sets of the output data 8 of “No. 4” and “No. 3” are used as the input data to the process_p, and the output data 8 of “No. 5” are generated by the process_p. The output data 8 of “No. 5” correspond to the learning data 9. The learning process a is conducted for the output data 8 of “No. 5”. For a model α acquired by the feature extraction process a and the learning process a, the accuracy “95%” is acquired.

The feature extraction process β includes five processes 7. At the initial stage, the process_b, a process_e, and a process_q are conducted. The output data 8 of “No. 1” is generated by the process_b, the output data 8 of “No. 6” is generated by the process_e, and the output data 8 of “No. 7” is generated by the process_q.

At the middle stage, two sets of the output data 8 of “No. 1” and “No. 6” are used as the input data to the process_m, and the output data 8 of “No 8” are generated by the process_m. At a subsequent stage, two sets of the output data 8 of “No. 8” and “No. 7” are used as the input data to the process_p, and the output data 8 of “No 9” are generated by the process_p. The output data 8 of “No 9” correspond to the learning data 9. The learning process a is conducted with respect to the output data 8 of “No. 9”. For a model β acquired by the feature extraction process β and the learning process α, the accuracy “78%” is acquired.

Referring to a data example of the meta information table 230 illustrated in FIG. 14, in the embodiment, it is not preferable to delete, from the repository 900, the two sets of the output data 8 of “No. 5” and “No. 9” generated by the feature extraction process α, and another process_p of the feature extraction process β, since the effect degree is relatively greater.

In contrast, in the feature extraction process β, the accuracy of the model β is lower, and the execution time of the process_p generating the output data 8 of “No. 7” at a previous stage is shorter. The effect by the process 7 on another process such as the process_p is relatively small. Hence, it is preferable to determine the output data 8 of “No. 7” as a subject deleted from the repository 900.

However, it is not preferable to separately determine the subject to delete for each set of the output data 8. It is preferable to determine which of the output data 8 is to be deleted by comparing one set of the output data 8 with another set of the output data 8. Accordingly, the deletion order is determined with respect to a plurality sets of the output data 8.

FIG. 14 is a diagram illustrating a data example of the meta information table. In FIG. 14, it is assumed that the consumed storage amount of the repository 900 is 500 MB, a constant number is 1 for a priority calculation, and the data example is illustrated for each of the process contents based on the process contents depicted in FIG. 13.

The meta information table 230 is regarded as a table for storing the output data 8 specified for each of the process contents, by associating with the priority referred to determine the deletion order, and various sets of information referred to calculate the priority.

The meta information table 230 includes a region 90a, and a region 90b. In the region 90a, a value acquired by executing the process 7, and the deletion effect information indicating the effect on another process 7 in a case of deleting the output data 8 are stored. In the region 90a, the contribution degree is stored after the execution of the learning process 50 (and the evaluation process 60). In the region 90b, a value acquired by normalizing a value acquired by the execution of the process 7 and the priority used to determine the deletion order of the output data 8 are stored.

Information stored in the region 90a is described with reference to FIG. 12, and the explanations for each of items will be omitted. The inverse number of the penalty is calculated based on the proportion of the output data size to the consumed storage amount of the repository 900. Respective execution time of included process contents are aggregated. The deletion effect information is calculated by multiplying the aggregated value with the use frequency.

In the region 90b, from items of the region 90a, the execution time, the inverse number of the penalty, the contribution degree, and deletion effect information are normalized and set. Respective normalized values for the items are multiplied with the constant number (“1” in this example), and are aggregated. The aggregated value is set to the priority.

In a data example in FIG. 14, the region 90a will be described with reference to the process content of the feature extraction process β in FIG. 13. Among the process_b, the process_e, and the process_q at the initial state of the feature extraction process β, the output data 8 of “No. 1” generated by the process_b are reused from the repository 900, and the process_b is omitted. Accordingly, the process content of the process_b is not stored in the meta information table 230.

The output data 8 of “No. 6” are generated by the process content “e”. The execution time “400”, the output data size “120”, the inverse number of the penalty “4.2”, and the contribution degree “78”% are stored in the meta information table 230.

The output data 8 of “No. 7” are generated by the process content “q”. The execution time “200”, the output data size “90”, the inverse number of the penalty “5.6”, and the contribution degree “78”% are stored in the meta information table 230. The deletion effect information is “200”.

The output data 8 of “No. 8” are generated by the process content “m{b}{e}”. The execution time “50”, the output data size “220”, the inverse number of the penalty “2.3”, and the contribution degree “78”% are stored in the meta information table 230. The deletion effect information is “750”.

The output data 8 of “No. 9” are generated by the process content “p{m{b}{e}}{q}”. The execution time “20”, the output data size “300”, the inverse number of the penalty “1.7”, and the contribution degree “78”% are stored in the meta information table 230. The deletion effect information is “970”.

Next, the region 90b will be described. The execution time, the inverse number of the penalty, the contribution degree, and the deletion effect information of the region 90a are normalized, and the normalized values are stored in respective items in the region 90b.

With respect to the process content “e”, the execution time “0.31”, the inverse number of the penalty “0.0020”, the contribution degree “0.06”, and the deletion effect information “0.31” are acquired by being normalized. The normalized values are stored in respective items in the region 90b. All the normalized values are multiplied by the constant number (=1) and aggregated. The priority “0.68” of the process content “e” is acquired and stored in the region 90b.

With respect to the process content “q”, the execution time “0.16”, the inverse number of the penalty “0.0030”, the contribution degree “0.06”, and the deletion effect information “0.16” are acquired by the normalization, and are set to respective items in the range 90b. All the normalized values are multiplied with the constant number (=1) and are aggregated. The priority “0.37” of the process content “q” is acquired and stored in the region 90b.

With respect to the process content “m{b}{e}”, the execution time “0.04”, the inverse number of the penalty “0.0005”, the contribution degree “0.06”, and the deletion effect information “0.59” are acquired by the normalization, and are set to respective items in the range 90b. All the normalized values are multiplied by the constant number (=1) and aggregated. The priority “0.68” of the process content “m{b}{e}” is acquired and stored in the region 90b.

With respect to the process content “p{m{b}{e}}{q}”, the execution time “0.01”, the inverse number of the penalty “0.0000”, the contribution degree “0.06”, and the deletion effect information “0.76” are acquired by the normalization, and are set to respective items in the range 90b. All the normalized values are multiplied by the constant number (=1) and aggregated. The priority “0.83” of the process content “p{m{b}{e}}{q}” is acquired and stored in the region 90b.

Depending on a capacity of the repository 900, the output data 8 are deleted in the ascending order of the priority. In this data example, first, the output data 8 of “No. 7” generated by the process content “q” are deleted. In contrast, the output data 8 of “No. 5” has a highest priority “1.10”, the output data 8 of “No. 3” has a next highest priority “0.86”, and the output data 8 of “No. 9” has a further next highest priority “0.83”.

These results correspond to explanations in which the output data 8 of “No. 7” have a relatively smaller effect degree, and two sets of the output data 8 of “No. 5” and “No. 9” have a relatively greater effect degree. Accordingly, due to the priority calculated in the present invention, it is possible to delete the output data 8 accumulated in the repository 900 with control against the increase of the data amount of the output data 8 to be accumulated.

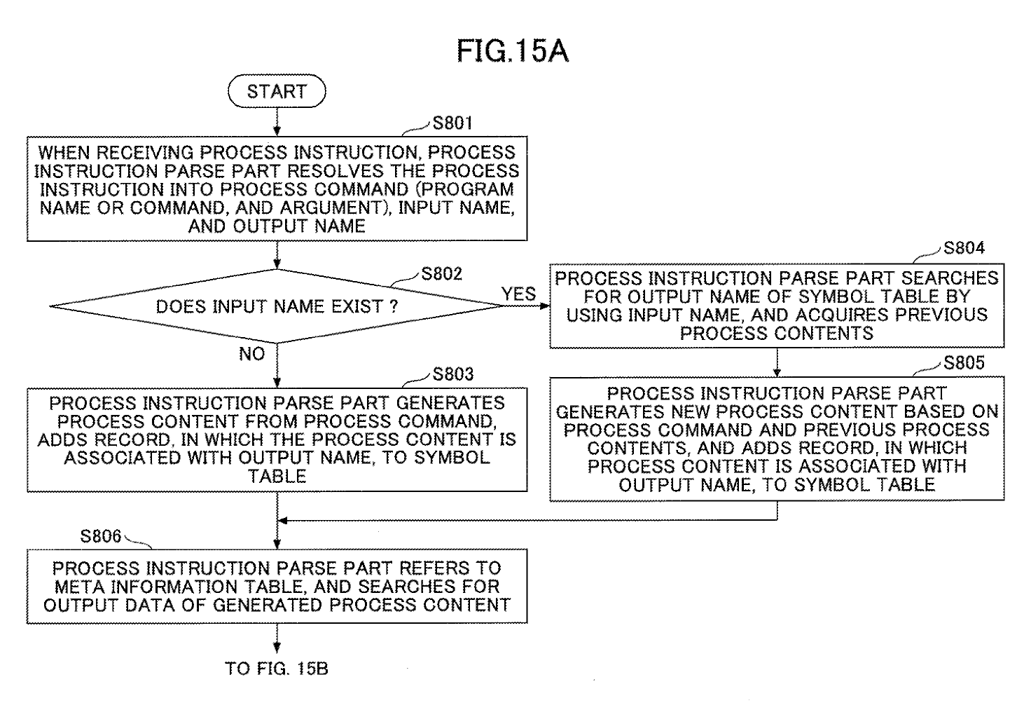

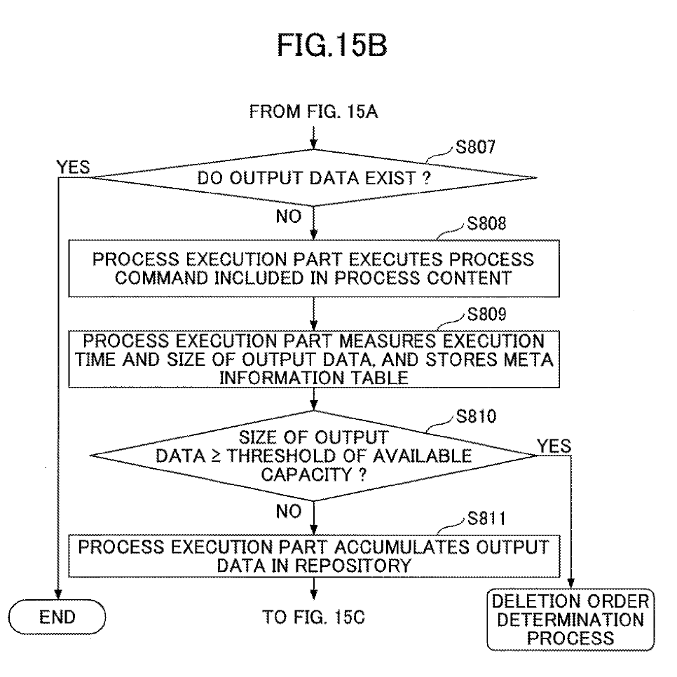

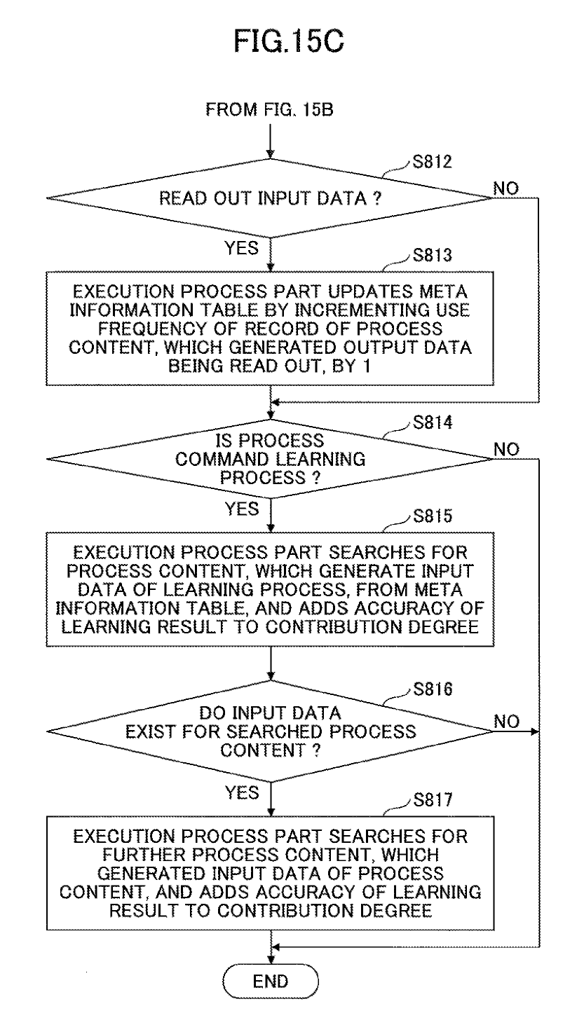

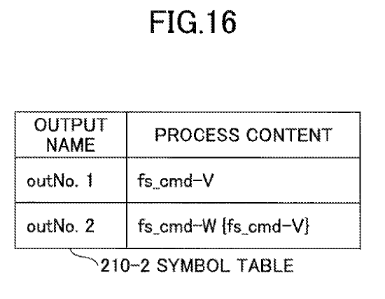

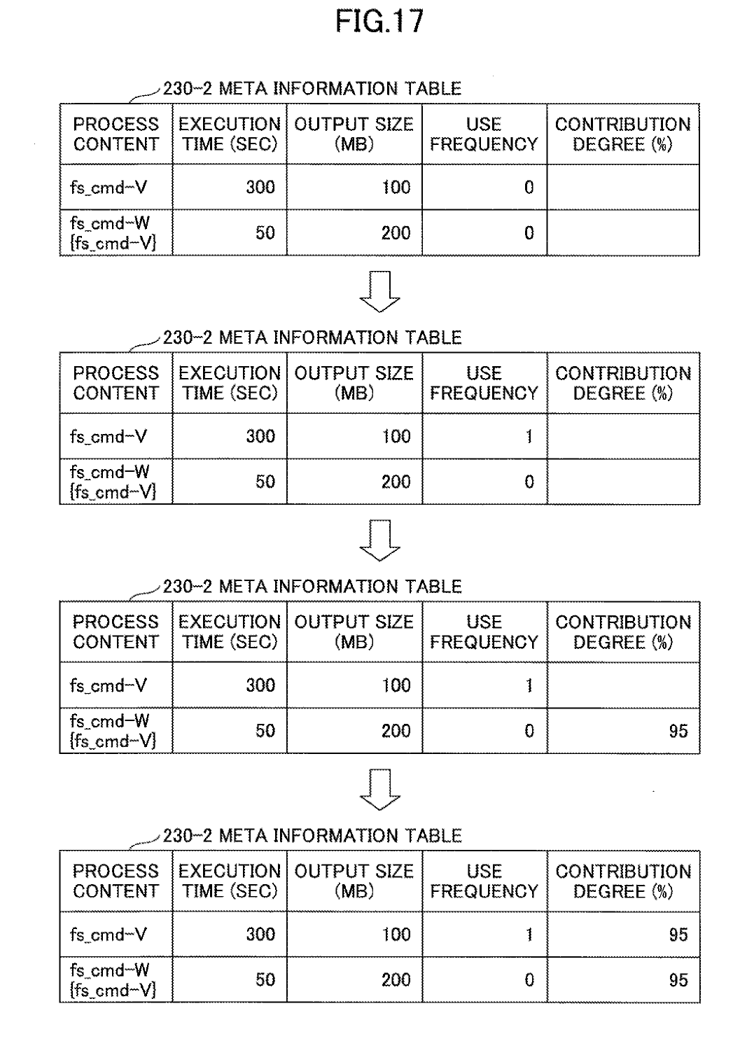

Next, a process from receiving the process instruction 39 until deleting the output data 8 in the repository 900 will be described. FIG. 15A, FIG. 15B, and FIG. 15C are flowcharts for explaining a second process example from receiving the process instruction until calculating the contribution degree. FIG. 16 and FIG. 17 are diagrams illustrating data examples in the second process example in FIG. 15A through FIG. 15C.

In FIG. 15A through FIG. 15C, the feature extraction process 40 is formed by simple process contents including fs_cmd-V and fs_cmd-W. In FIG. 15A through FIG. 15C, it is assumed that the output data 8 generated by fs_cmd-V are input to fs_cmd-W, and the output data 8 of fs_cmd-W correspond to the learning data 9. Also, it is assumed that information of fs_cmd-V has been stored in the symbol table 210 and the meta information table 230. Hence, in the following, the second process example will be described by corresponding to the data examples depicted in FIG. 16 and FIG. 17.

Referring to FIG. 15, when receiving the process instruction 39, the process instruction parsing part 310 parses the process instruction 39, and resolves the process instruction 39 into the process command including the program name or the command of the process and the argument, the input name, and the output name (step S801).

The process instruction parsing part 310 determines whether the input name exists (step S802). When there is no input name (NO of step S802), the process instruction parsing part 310 generates the process content from the process command, and adds a record in which the generated process content is associated with the output name, in the symbol table 210-2 (step S803).

In contrast, when there is the input name (YES of step S802), the process instruction parsing part 310 searches for the output names in the symbol table 210-2 by using the input name, and acquires the previous process content (step S804). Next, the process instruction parsing part 310 generates a new process content by using the process command and the acquired previous process contents, and adds a record in which the new process content is associated with the output name, to the symbol table 210-2 (step S802).

The process content “fs_cmd-V” has been stored in the symbol table 210-2 (FIG. 16) and is associated with the output name “outNo. 1”. Moreover, the information pertinent to “fs_cmd-W” is added. The output data 8 “outNo. 1” of “fs_cmd-V” are entered as the input data to “fs_cmd-W”. Thus, the process content of “fs_cmd-W” are represented by the process content “fs_cmd-W{fs_cmd-V}”. The process content “fs_cmd-W{fs_cmd-V}” are associated with the output data 8 “outNo. 2” of “fs_cmd-W”, and are added in the symbol table 210-2.

After step S803 or S805, the output data search part 320 refers to the meta information table 230 (FIG. 17) and searches for the output data 8 of the generated process content (step S806). It is searched whether the generated process content exists in the meta information table 230 (FIG. 17). When the generated process content exist, it is determined that there are output data 8.

Referring to FIG. 15B, the output data search part 320 determines whether the output data 8 exist (step S807). When the output data 8 exist (YES of step S807), the process conducted by the process part 300 is terminated.

In contrast, when the output data 8 do not exist (NO of step S807), the process execution part 330 reads out the input data from the repository 900 by using the process content generated by the process instruction parsing part 310, and executes the process command (step S808). The output data 8 of the previous process content included in the process content are retrieved as the input data.

The process execution part 330 measures the execution time for the execution of the command and the size of the output data 8 generated by the execution, and stores the measured execution time and the measured size of the output data 8 generated by the execution in the meta information table 230-2 (step S809).

Referring to FIG. 17, the meta information table 230-2 has stored a record, in which the execution time “300” seconds, the output size “100” MB, and the use frequency “0” are corresponded to the process content “fs_cmd-V”. However, the contribution degree is not set.

Moreover, regarding the executed “fs_cmd-W”, the meta information table 230-2 has stored a record, in which the execution time “50” seconds, the output size “200” MB, and the use frequency “0” are corresponded to the process content “fs_cmd-W”. However, the contribution degree is not set.

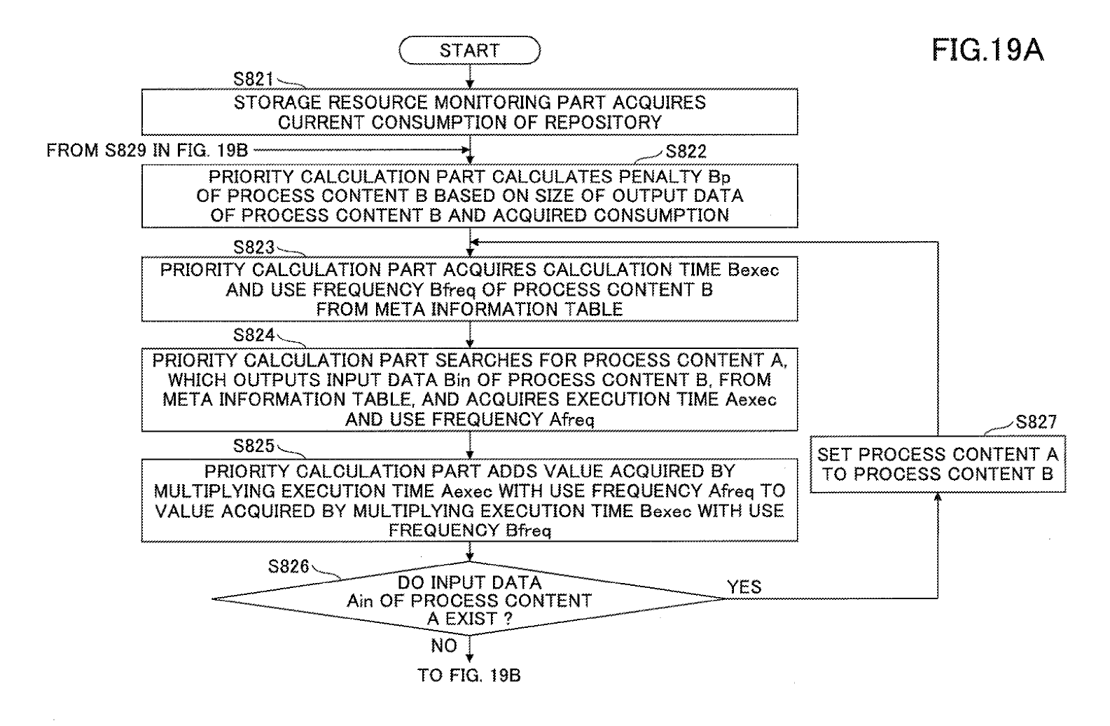

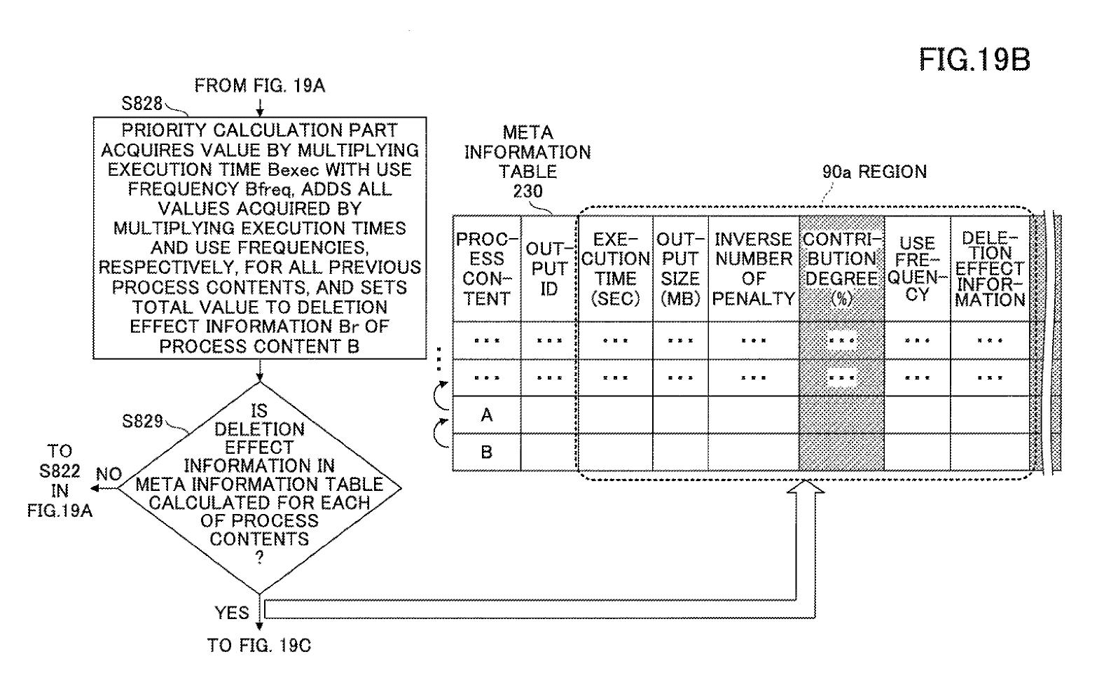

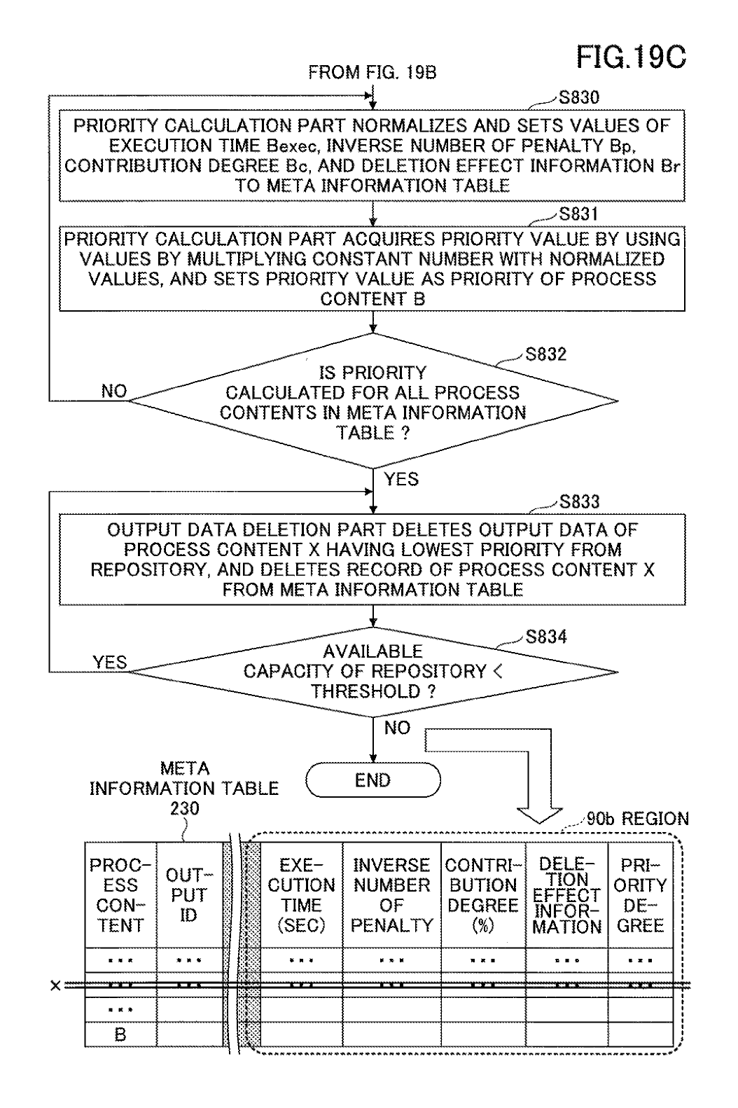

Next, the process execution part 330 determines whether the measured size of the output data 8 is greater than or equal to the threshold for the available capacity of the repository 900 (step S810). When the measured size of the output data 8 is greater than or equal to the threshold for the available capacity (YES of step S810), the deletion order determination process, which will be described later with reference to FIG. 19A through FIG. 19C, is conducted.

In contrast, when the measured size of the output data 8 is smaller than the threshold for the available capacity (NO of step S810), the output data 8 generated by the process execution part 330 are accumulated in the repository 900 (step S811).

Referring to FIG. 15C, the process execution part 330 determines whether the output data 8 are read out from the repository 900 as the input data (step S812). When the output data 8 are not read out as the input data (NO of step S812), the process execution part 330 advances to step S814.

In contrast, when the output data 8 are read out as the input data (YES of step S812), the process execution part 330 updates the meta information table 230-2 by adding 1 to the use frequency of the record of the process content, which generated the read output data 8 (step S813).

Since the output data 8 “outNo. 1” generated by “fs_cmd-V” are used as the input data for “fs_cmd-W”, the use frequency is incremented by 1 in the record of the process content “fs_cmd-V” in the meta information table 230-2.

The process execution part 330 determines whether the process command indicates the learning process 50 (step S814). It is determined whether the prefix is “ml_”. When the process command does not indicate the learning process 50 (NO of step S814), the second process example is terminated, and is repeated upon receiving a next process instruction 39. When “fs_cmd-W” is a process subject, since “fs_cmd-W” is not the learning process, the second process example is terminated. At the next process instruction 39, the process command having the prefix “ml_” for conducting the learning process 50 is received and executed by the process execution part 330. Next, it is determined that the process command corresponds to the learning process 50 in step S814. A model having the accuracy “95” % is acquired by the learning process 50.

When the process command corresponds to the learning process 50 (YES of step S814), the process execution part 330 searches for the previous process content generating the input data (the learning data 9) for the learning process, from the meta information table 230, and adds the accuracy of the model to the contribution degree (step S815).

“95” % is added to the contribution degree of the process content “fs_cmd-W{fs_cmd-V}” immediately before the learning process 50.

Next, the process execution part 330 further determines whether there are the input data for the searched process content (step S816) When there are the input data (NO of step S816), the second process example is terminated, and repeats upon receiving the next process instruction 39 from step S801.

In contrast, when there are the input data (YES of step S816), the process execution part 330 further searches for the process content generating the input data of the learning process from the meta information data 230-2, and adds the accuracy of the model to the contribution degree (step S817).

The process content “{fs_cmd-V}” is specified from the process content “fs_cmd-W{fs_cmd-V}”, and is searched from the meta information table 230-2. “95” % is added to the contribution degree of the process content “{fs_cmd-V}”.

In a case of a more complicated process content, steps S816 and S817 are repeated until all inclusive process contents are processed.

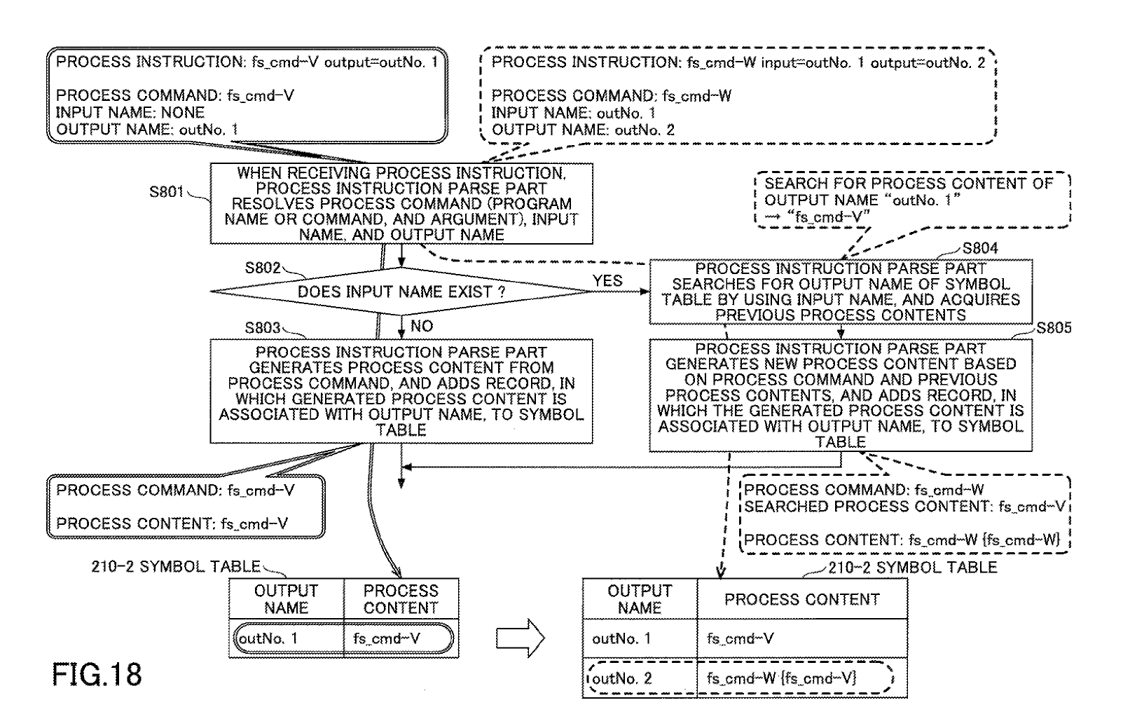

A generation of the process content by steps S802 through S805 in FIG. 15 will be described, by referring to the above described process contents. FIG. 18 is a diagram for explaining a generation example of the process content. Referring to FIG. 18, when receiving the process instruction 39 of “fs_cmd-V output=outNo. 1”, the process instruction parsing part 310 resolves the process instruction 39 into the process command, the input name, and the output name as follows (step S801):
process command: fs_cmd-V
input name: none
output name: outNo. 1.

Since the input name does not exist (NO of step S802), the process instruction parsing part 310 generates the process content “fs_cmd-V” from the process command “fs_cmd-V”, and adds the generated process content “fs_cmd-V” to the symbol table 210-2 (step S803).

When receiving the next process instruction 39 of “fs_cmd-W input=outNo. 1 output=outNo. 2”, the process instruction parsing part 310 resolves the process instruction 39 into the process command, the input name, and the output name as follows (step S801):
process command: fs_cmd-W
input name: outNo. 1
output name: outNo. 2.

Since there is an input name (YES of step S802), the process instruction parsing part 310 searches for the output name of the symbol table 210-2 by using the input name “outNo. 1” based on the process command “fs_cmd-W input=outNo. 1 output=outNo. 2”, and acquires the previous process content “fs_cmd-V” (step S804).

Next, the process instruction parsing part 310 generates a new process content “fs_cmd-W {fs_cmd-W}” by using the process content “fs_cmd-W” and the previous process content “fs_cmd-V”, and adds a record, in which the process content “fs_cmd-V” is associated with the output name “outNo. 2”, to the symbol table 210-2 (step S805).

Next, a second example of the deletion order determination process 399 will be described with reference to FIG. 19A through FIG. 19C. In the second example, the deletion order determination process 399 using the meta information table 230 will be described in a case in which the output data size is greater than or equal to the threshold for the available capacity (YES of step S810 in FIG. 15B).

FIG. 19A through FIG. 19C are flowcharts for explaining the second example of the deletion order determination process. Referring to FIG. 19A, the storage resource monitoring part 340 acquires the current storage amount of the repository 900 (step S821).

The priority calculation part 350 calculates a penalty Bp of a process content B, for which the deletion effect information has not been set, based on the size of the output data of the process content B, and the acquired consumed storage amount by referring to the meta information table 230 (step S822).

Next, the priority calculation part 350 acquires an execution time Bexec and the use frequency Bfreq of the process content B from the meta information table 230 (step S823). Also, the priority calculation part 350 searches for a process content A outputting input data B in of the process content B from the meta information table 230, and acquires an execution Aexec and a use frequency Afeq (step S824).

The priority calculation part 350 adds a first value acquired by multiplying the execution time Aexec with the user frequency Afreq, to a second value acquired by multiplying the execution time Bexec with the user frequency Bfreq (step S825)

The priority calculation part 350 determines whether there are input data Ain of the process content A (step S826). When there are the input data Ain (YES of step S826), the priority calculation part 350 sets the process content A as the process content B (step S827), and goes back to step S823 to repeat the above described process in the same manner.

In contrast, when there are no input data Ain (NO of step S826), referring to FIG. 19B, the priority calculation part 350 adds all the first values, each of which is acquired by multiplying the execution time with the user frequency for each of the previous process contents, to the second value acquired by multiplying the execution time Bexec with the user frequency Bfreq, and determines a total value as the deletion effect information Br of the process content B (step S828). In the meta information table 230, the deletion effect information Br is set in the record of the latest process content B, which is set as the process subject in step S822).

Next, the priority calculation part 350 determines whether the deletion effect information is calculated for each of the process contents retained in the meta information table 230 (step S829). When there is the process content, for which the deletion effect information has not been calculated (NO of step S829), the priority calculation part 350 goes back to step S822, and the above described process is repeated in the same manner.

In contrast, when the deletion effect information is calculated for each of the process contents (YES of step S829), at this state, settings of values of the items other than the contribution degree in the region 90a in the meta information table 230 are completed. In this case, the priority calculation part 350 advances to step S380 in FIG. 19C.

Referring to FIG. 19C, the priority calculation part 350 normalizes values of the execution time Bexec, the inverse number of the penalty Bp, the contribution degree Bc, and the deletion effect information Br, and sets the normalized values to respective items in the region 90b of the meta information table 230 (step S830).

The priority calculation part 350 sets the total of multiple values acquired by multiplying the normalized values with the constant number to the priority of the process content B in the meta information table 230 (step S831). Then, the priority calculation part 350 determines whether the priority is calculated for all the process contents in the meta information table 230 (step S832). When there is process content, for which the priority has not been calculated (NO of step S832), the priority calculation part 350 sets the process content in a next record, goes back to step S830, and repeats the above described process in the same manner.

In contrast, when the priority is calculated for all the process contents (YES of step S832), the output data deletion part 360 deletes the output data 8 of a process content X having the lowest priority from the repository 900, and deletes a record of the process content X from the meta information table 230 (step S833).

Next, the storage resource monitoring part 340 determines whether the available capacity of the repository 900 is less than the threshold for conducting the deletion order determination (step S834). When the available capacity is less than the threshold (YES of step S834), the deletion order determination process goes back to step S833, and repeats to delete the output data 8 by the output data deletion part 360.

In contrast, when the available capacity is greater than or equal to the threshold (NO of step S834), the deletion order determination process is terminated.

Processes from steps S821 through S829 in FIG. 19A and FIG. 19B correspond to a process pertinent to the calculation of the values of the items of the region 90a in the meta information table 230. Processes from steps S830 through S834 in FIG. 19C correspond to a process pertinent to the calculation of the values of the items of the region 90b in the meta information table 230.

The output data 8 accumulated during the machine learning is directly reused. In addition, the output data 8 may be used for another calculation. Hence, it is not always preferable to delete the output data 8 based on a direct use prediction alone.

In contrast, in the embodiment, in a case of deleting the output data 8, as described above, the output data 8 having a greater effect on another process and the output data 8 having a smaller effect on another process are distinguished. By deleting the output data 8 having the smaller effect, it is possible to delete the output data 8 in a state of suppressing the effect due to the deletion. That is, better control of effects due to deletion is realized.

According to the embodiment, in a data process formed by a multiple processes in which an output result of a process is cumulatively stored in a memory to use by another process, it is possible to realize the deletion of accumulated data of the output result, to control against effects due to deletion.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a data deletion determining program that causes a computer to execute a process comprising:
generating deletion effect information indicating effect degrees due to deletions of a plurality of sets of output data based on process contents, output data information, and an execution time, the plurality of sets of output data being generated over a course of a plurality of processes acquiring a final result acquired through a plurality of processes from subject data, the process contents being related to each of the plurality of processes, the output information being accumulated in a memory for the plurality of sets of the output data, the execution time being taken for one or more of the processes until generating the output data; and
extracting the output data to be deleted from the memory based on respective sets of the deletion effect information for the plurality of the sets of the output data.

2. The non-transitory computer-readable recording medium as claimed in claim 1, further comprising:
acquiring the deletion effect information by calculating a total of values each acquired by multiplying a use frequency of the output data in the plurality of processes with the execution time for each of previous processes related to a process, which generates the output data.

3. The non-transitory computer-readable recording medium as claimed in claim 2, further comprising
determining a priority by the deletion effect information related to the process contents represented based on inputs and outputs among the plurality of processes so as to retain the output data affecting another process in the memory.

4. The non-transitory computer-readable recording medium as claimed in claim 2, further comprising:
storing, in a table, the execution time, a size of the output data, an inverse number of a penalty, the use frequency, a contribution degree, and the deletion effect information, to be associated with the process contents being represented including the previous processes conducted until generating the output data, the inverse number of the penalty indicating an occupation degree of the output data with respect to a consumed storage amount of the memory, the contribution degree indicating a degree to what extent the process contents contributes to the final result acquired through the plurality of processes;
referring to the table, normalizing the execution time, the inverse number of the penalty, the contribution, and the deletion effect information, calculating a total of values acquired by multiplying respective normalized values with a constant number, determining a priority of the output data to remain in the memory, and storing the determined priority in the table by corresponding to the process contents; and
deleting the output data from the memory in an ascending order of the priority in the table until an available storage amount of the memory becomes greater than or equal to a threshold.

5. A data deletion determining method by a computer, comprising:
generating deletion effect information indicating effect degrees due to deletions of a plurality of sets of output data based on process contents, output data information, and an execution time, the plurality of sets of output data being generated over a course of a plurality of processes acquiring a final result acquired through a plurality of processes from subject data, the process contents being related to each of the plurality of processes, the output information being accumulated in a memory for the plurality of sets of the output data, the execution time being taken for one or more of the processes until generating the output data; and
extracting the output data to be deleted from the memory based on respective sets of the deletion effect information for the plurality of the sets of the output data.

6. A data deletion determining apparatus, comprising:
a memory; and
a processor coupled to the memory and the processor configured to:
generate deletion effect information indicating effect degrees due to deletions of a plurality of sets of output data based on process contents, output data information, and an execution time, the plurality of sets of output data being generated over a course of a plurality of processes acquiring a final result acquired through a plurality of processes from subject data, the process contents being related to each of the plurality of processes, the output information being accumulated in a memory for the plurality of sets of the output data, the execution time being taken for one or more of the processes until generating the output data; and
extract the output data to be deleted from the memory based on respective sets of the deletion effect information for the plurality of the sets of the output data.
